(19) United States
(12) Patent Application Publication
(10) Pub. No.: US 2026/0259809 A1
(43) Pub. Date: Sep. 3, 2026

(54) USER INTERFACES FOR PROVIDING CONTEXTUAL NOTIFICATIONS

(71) Applicant: Apple Inc., Cupertino, CA (US)

(72) Inventors: Edward CHAO, Palo Alto, CA (US); Adam J. LEONARD, San Francisco, CA (US)

(21) Appl. No.: 19/435,231

(22) Filed: Dec. 29, 2025

Related U.S. Application Data
(60) Provisional application No. 63/765,488, filed on Feb. 28, 2025.

(51) Int. Cl. G06F 11/32; G06F 11/30

(52) U.S. Cl. CPC G06F 11/32; G06F 11/3055

(57) ABSTRACT

The present disclosure generally relates to methods and user interfaces for providing contextual notifications, including methods and user interfaces for providing proactive contextual notifications and methods and user interfaces for providing variable confidence notifications, in accordance with some embodiments.

### CROSS-REFERENCE TO RELATED APPLICATIONS

This application claims priority to U.S. patent application Ser. No. 63/765,488, entitled “USER INTERFACES FOR PROVIDING CONTEXTUAL NOTIFICATIONS,” filed on Feb. 28, 2025, the content of which is hereby incorporated by reference in its entirety.

### FIELD

The present disclosure relates generally to computer user interfaces, and more specifically to techniques for providing contextual notifications.

### BACKGROUND

Electronic devices include displays and user interface that can be used to display various types of content and to provide information to a user. Some electronic devices, such as smartphones and smartwatches, can display user interfaces that include a notification, including notifications regarding a context of the electronic device.

### BRIEF SUMMARY

Some techniques for providing contextual notifications using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for providing contextual notifications. Such methods and interfaces optionally complement or replace other methods for providing contextual notifications. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with one or more display generation components: displaying, via the one or more display generation components, in a first user interface, a contextual notification, wherein: the contextual notification is displayed based on a context of the computer system being a first context that meets a first set of context criteria; the contextual notification is associated with an action that is not displayed as being available in the first user interface other than through interaction with the contextual notification; and the contextual notification is overlaid on first content of the first user interface; after concurrently displaying the first content and the contextual notification, detecting that the context of the computer system has changed from the first context to a second context that does not meet the first set of context criteria; and in response to detecting the change in context of the computer system from the first context to the second context, automatically dismissing the contextual notification.

In accordance with some embodiments, a non-transitory computer-readable storage medium storing one or more programs configured to be executed by one or more processors of a computer system that is in communication with one or more display generation components is described. The one or more programs include instructions for: displaying, via the one or more display generation components, in a first user interface, a contextual notification, wherein: the contextual notification is displayed based on a context of the computer system being a first context that meets a first set of context criteria; the contextual notification is associated with an action that is not displayed as being available in the first user interface other than through interaction with the contextual notification; and the contextual notification is overlaid on first content of the first user interface; after concurrently displaying the first content and the contextual notification, detecting that the context of the computer system has changed from the first context to a second context that does not meet the first set of context criteria; and in response to detecting the change in context of the computer system from the first context to the second context, automatically dismissing the contextual notification.

In accordance with some embodiments, a transitory computer-readable storage medium storing one or more programs configured to be executed by one or more processors of a computer system that is in communication with one or more display generation components. The one or more programs include instructions for: displaying, via the one or more display generation components, in a first user interface, a contextual notification, wherein: the contextual notification is displayed based on a context of the computer system being a first context that meets a first set of context criteria; the contextual notification is associated with an action that is not displayed as being available in the first user interface other than through interaction with the contextual notification; and the contextual notification is overlaid on first content of the first user interface; after concurrently displaying the first content and the contextual notification, detecting that the context of the computer system has changed from the first context to a second context that does not meet the first set of context criteria; and in response to detecting the change in context of the computer system from the first context to the second context, automatically dismissing the contextual notification.

In accordance with some embodiments, a computer system configured to communicate with one or more display generation components. The computer system comprises: one or more processors; and memory storing one or more programs configured to be executed by the one or more processors, the one or more programs including instructions for: displaying, via the one or more display generation components, in a first user interface, a contextual notification, wherein: the contextual notification is displayed based on a context of the computer system being a first context that meets a first set of context criteria; the contextual notification is associated with an action that is not displayed as being available in the first user interface other than through interaction with the contextual notification; and the contextual notification is overlaid on first content of the first user interface; after concurrently displaying the first content and the contextual notification, detecting that the context of the computer system has changed from the first context to a second context that does not meet the first set of context criteria; and in response to detecting the change in context of the computer system from the first context to the second context, automatically dismissing the contextual notification.

In accordance with some embodiments, a computer system configured to communicate with one or more display generation components. The computer system comprises: means for displaying, via the one or more display generation components, in a first user interface, a contextual notification, wherein: the contextual notification is displayed based on a context of the computer system being a first context that meets a first set of context criteria; the contextual notification is associated with an action that is not displayed as being available in the first user interface other than through interaction with the contextual notification; and the contextual notification is overlaid on first content of the first user interface; means for, after concurrently displaying the first content and the contextual notification, detecting that the context of the computer system has changed from the first context to a second context that does not meet the first set of context criteria; and means for, in response to detecting the change in context of the computer system from the first context to the second context, automatically dismissing the contextual notification.

In accordance with some embodiments, a computer program product is described. The computer program product comprises one or more programs configured to be executed by one or more processors of a computer system that is in communication with one or more display generation components, the one or more programs including instructions for: displaying, via the one or more display generation components, in a first user interface, a contextual notification, wherein: the contextual notification is displayed based on a context of the computer system being a first context that meets a first set of context criteria; the contextual notification is associated with an action that is not displayed as being available in the first user interface other than through interaction with the contextual notification; and the contextual notification is overlaid on first content of the first user interface; after concurrently displaying the first content and the contextual notification, detecting that the context of the computer system has changed from the first context to a second context that does not meet the first set of context criteria; and in response to detecting the change in context of the computer system from the first context to the second context, automatically dismissing the contextual notification.

In accordance with some embodiments, a method is described. The method comprises: at a computer system that is in communication with one or more display generation components: detecting a change in context of the computer system; and in response to detecting the change in the context: in accordance with a determination that a confidence level that the computer system is in a respective context is within a first range of confidence values, initiating a process for providing information about a respective action corresponding to the respective context in a first manner; and in accordance with a determination that the confidence level is within a second range of confidence values that is different from the first range, initiating a process for providing information about the respective action corresponding to the respective context in a second manner that is different from the first manner.

In accordance with some embodiments, a non-transitory computer-readable storage medium storing one or more programs configured to be executed by one or more processors of a computer system that is in communication with one or more display generation components is described. The one or more programs include instructions for: detecting a change in context of the computer system; and in response to detecting the change in the context: in accordance with a determination that a confidence level that the computer system is in a respective context is within a first range of confidence values, initiating a process for providing information about a respective action corresponding to the respective context in a first manner; and in accordance with a determination that the confidence level is within a second range of confidence values that is different from the first range, initiating a process for providing information about the respective action corresponding to the respective context in a second manner that is different from the first manner.

In accordance with some embodiments, a transitory computer-readable storage medium storing one or more programs configured to be executed by one or more processors of a computer system that is in communication with one or more display generation components is described. The one or more programs include instructions for: detecting a change in context of the computer system; and in response to detecting the change in the context: in accordance with a determination that a confidence level that the computer system is in a respective context is within a first range of confidence values, initiating a process for providing information about a respective action corresponding to the respective context in a first manner; and in accordance with a determination that the confidence level is within a second range of confidence values that is different from the first range, initiating a process for providing information about the respective action corresponding to the respective context in a second manner that is different from the first manner.

In accordance with some embodiments, a computer system configured to communicate with one or more display generation components is described. The computer system comprises: one or more processors; and memory storing one or more programs configured to be executed by the one or more processors, the one or more programs including instructions for: detecting a change in context of the computer system; and in response to detecting the change in the context: in accordance with a determination that a confidence level that the computer system is in a respective context is within a first range of confidence values, initiating a process for providing information about a respective action corresponding to the respective context in a first manner; and in accordance with a determination that the confidence level is within a second range of confidence values that is different from the first range, initiating a process for providing information about the respective action corresponding to the respective context in a second manner that is different from the first manner.

In accordance with some embodiments, a computer system configured to communicate with one or more display generation components is described. The computer system comprises: means for detecting a change in context of the computer system; and means for, in response to detecting the change in the context: in accordance with a determination that a confidence level that the computer system is in a respective context is within a first range of confidence values, initiating a process for providing information about a respective action corresponding to the respective context in a first manner; and in accordance with a determination that the confidence level is within a second range of confidence values that is different from the first range, initiating a process for providing information about the respective action corresponding to the respective context in a second manner that is different from the first manner.

In accordance with some embodiments, a computer program product is described. The computer program product comprises one or more programs configured to be executed by one or more processors of a computer system that is in communication with one or more display generation components, the one or more programs including instructions for: detecting a change in context of the computer system; and in response to detecting the change in the context: in accordance with a determination that a confidence level that the computer system is in a respective context is within a first range of confidence values, initiating a process for providing information about a respective action corresponding to the respective context in a first manner; and in accordance with a determination that the confidence level is within a second range of confidence values that is different from the first range, initiating a process for providing information about the respective action corresponding to the respective context in a second manner that is different from the first manner.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for providing contextual notifications, thereby increasing the effectiveness, efficiency, and user satisfaction with such devices. Such methods and interfaces may complement or replace other methods for providing contextual notifications.

### DESCRIPTION OF THE FIGURES

For a better understanding of the various described embodiments, reference should be made to the Description of Embodiments below, in conjunction with the following drawings in which like reference numerals refer to corresponding parts throughout the FIGURES.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6N illustrate techniques for displaying contextual notifications, in accordance with some embodiments.

FIG. 7 is a flow diagram illustrating a method for providing proactive contextual notifications, in accordance with some embodiments.

FIG. 8 is a flow diagram illustrating a method for providing variable confidence notifications, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for providing contextual notifications. Such techniques can reduce the cognitive burden on a user who accesses contextual notifications, thereby enhancing productivity. Further, such techniques can reduce processor and battery power otherwise wasted on redundant user inputs.

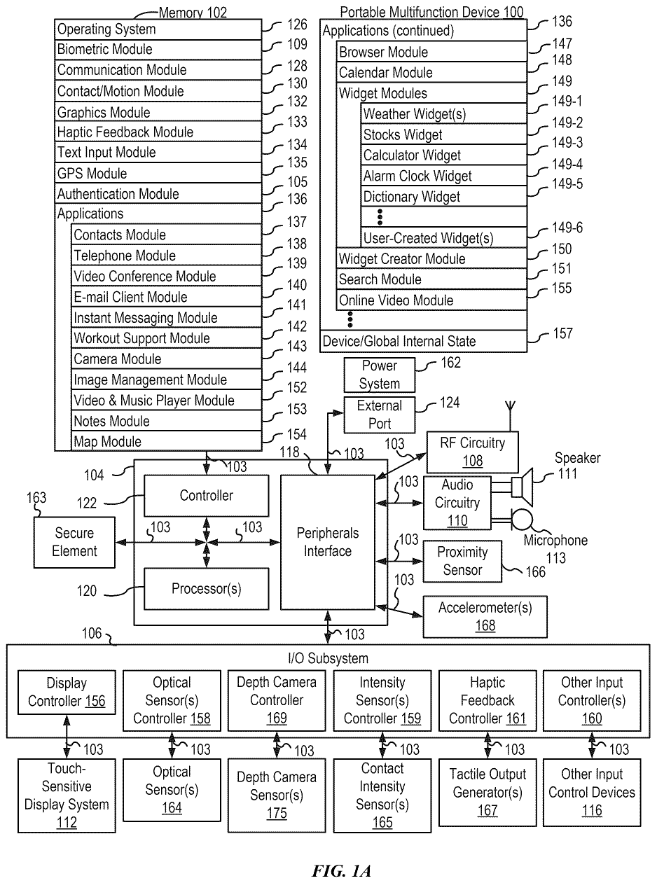

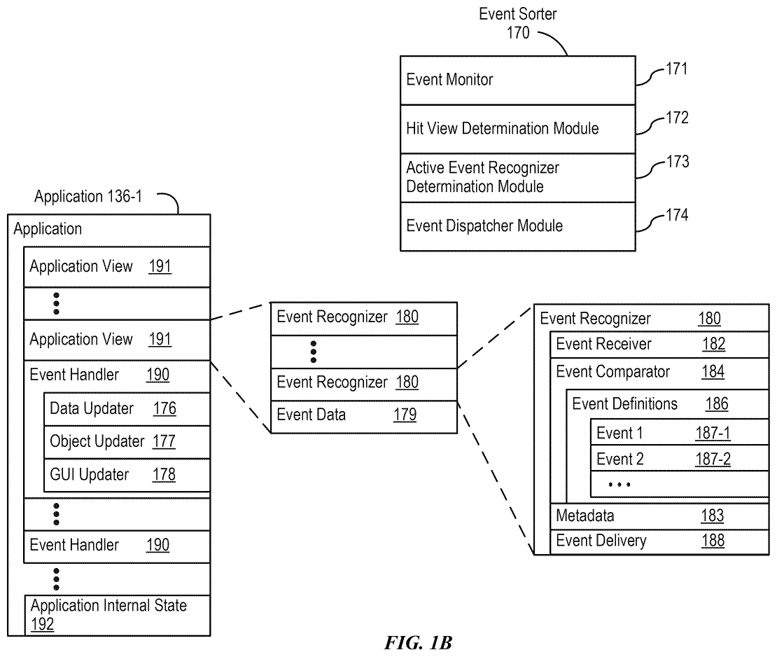

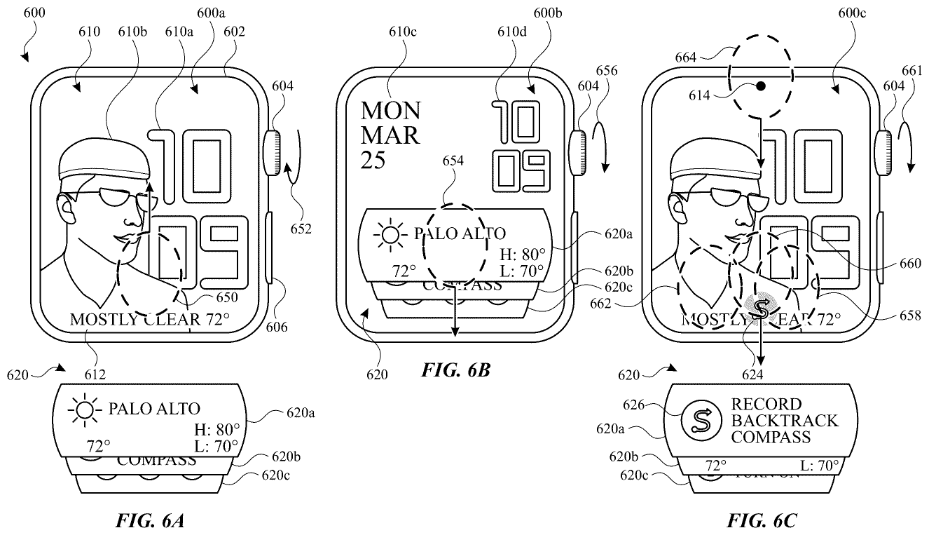

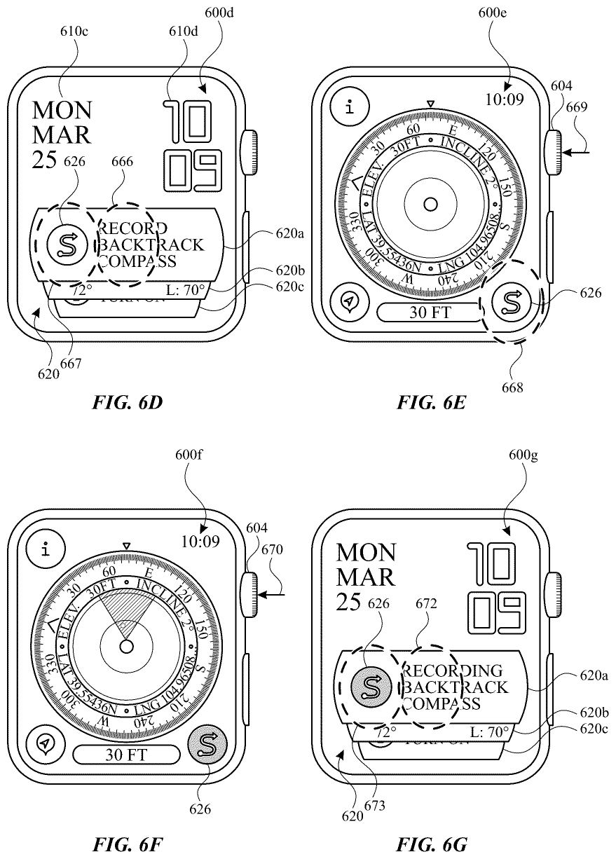

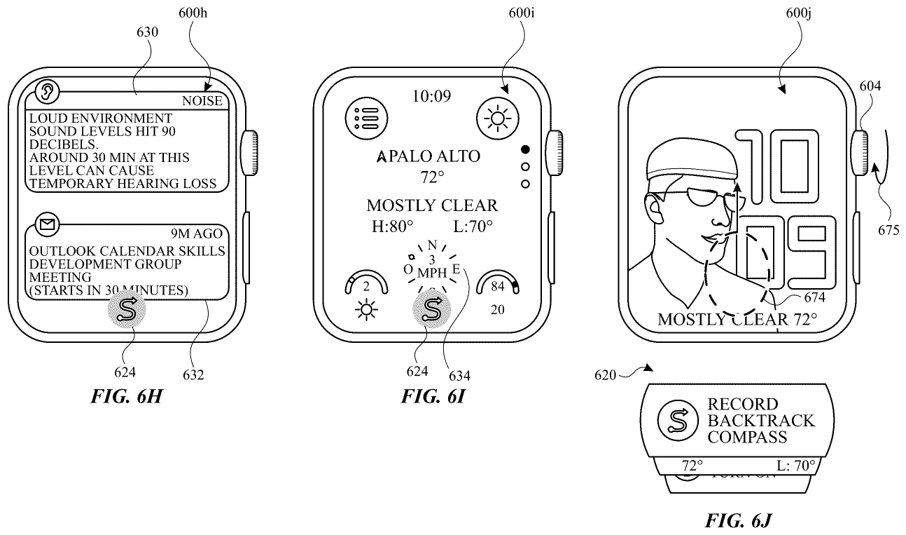

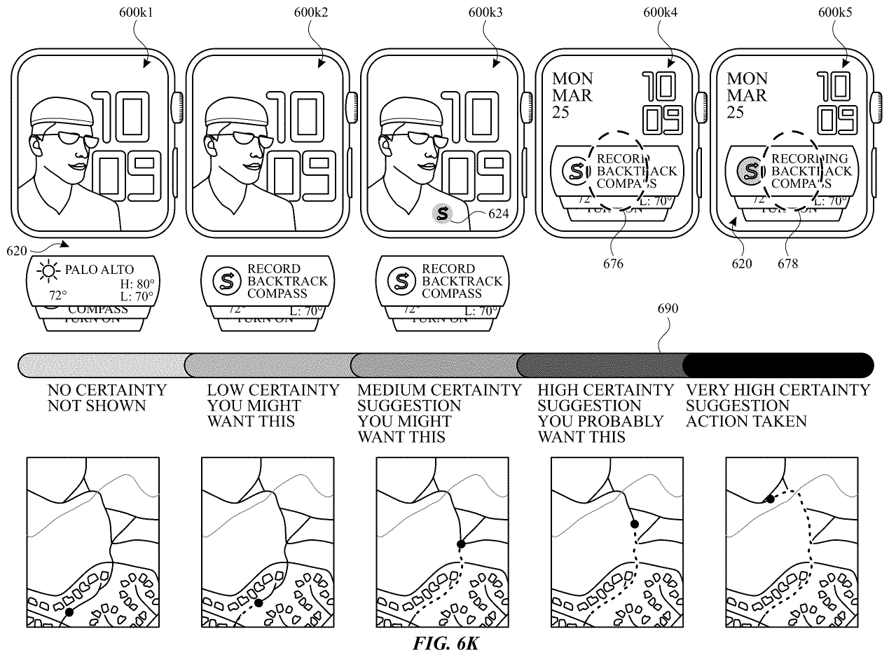

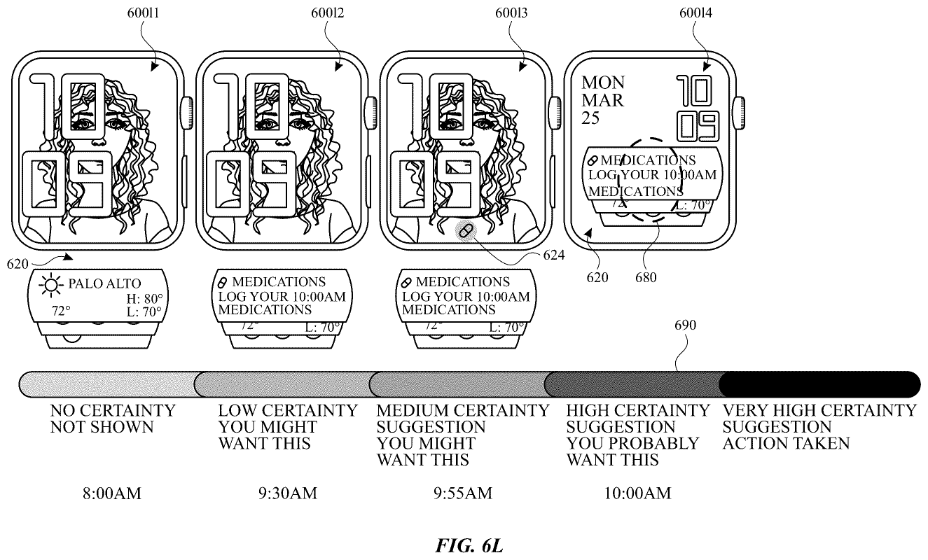

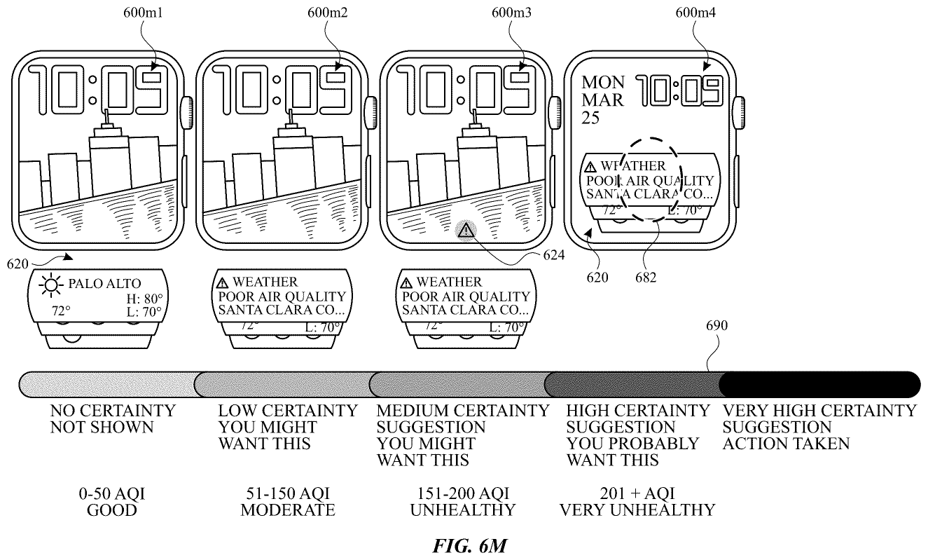

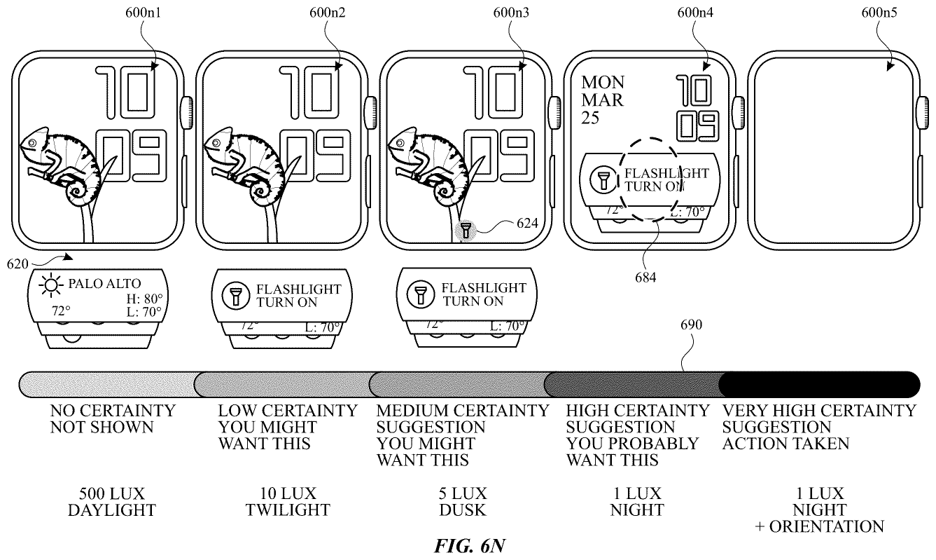

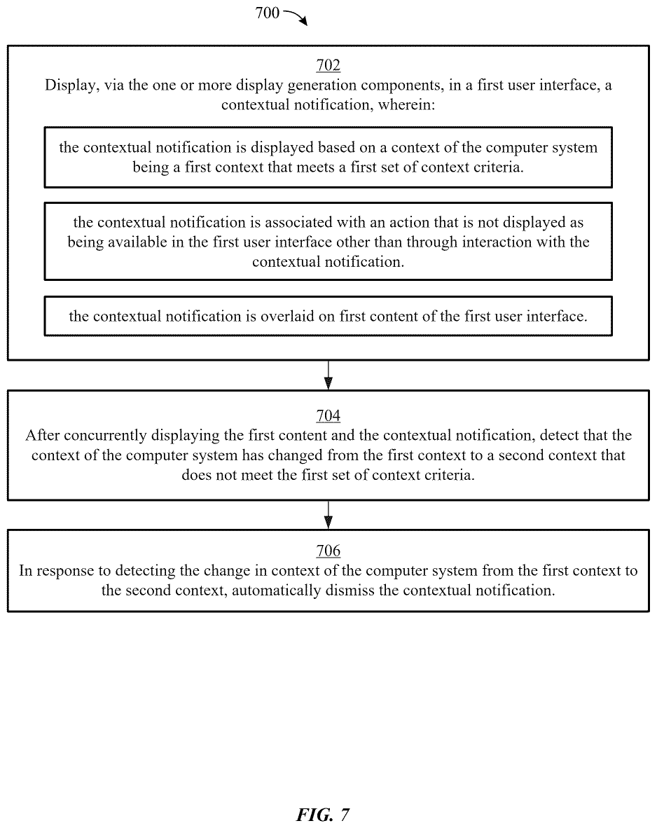

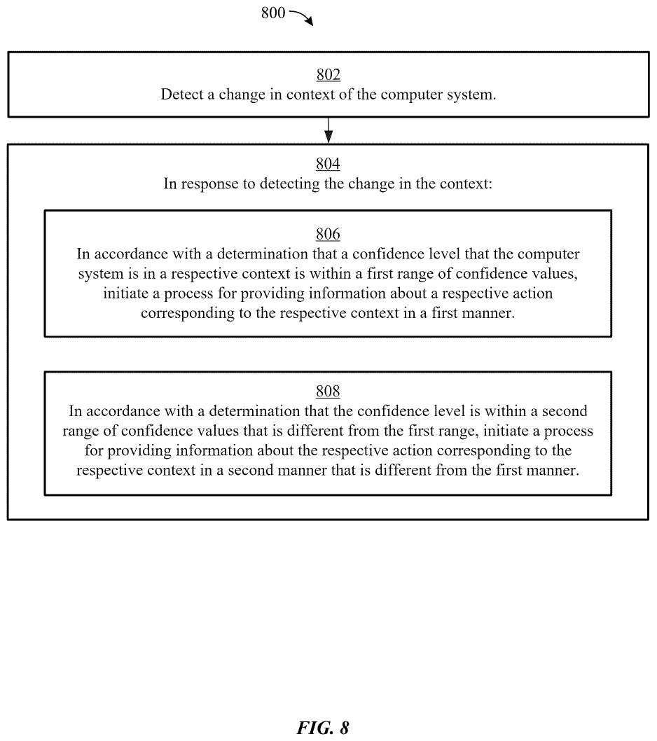

Below, FIGS. 1A-1B, 2, 3A-3G, 4A-4B, and 5A-5B provide a description of exemplary devices for performing the techniques for managing event notifications. FIGS. 6A-6N illustrate exemplary user interfaces for displaying contextual notifications. FIG. 7 is a flow diagram illustrating methods for providing proactive contextual notifications in accordance with some embodiments. FIG. 8 is a flow diagram illustrating methods for providing variable confidence notifications in accordance with some embodiments. The user interfaces in FIGS. 6A-6N are used to illustrate the processes described below, including the processes in FIG. 7 and FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

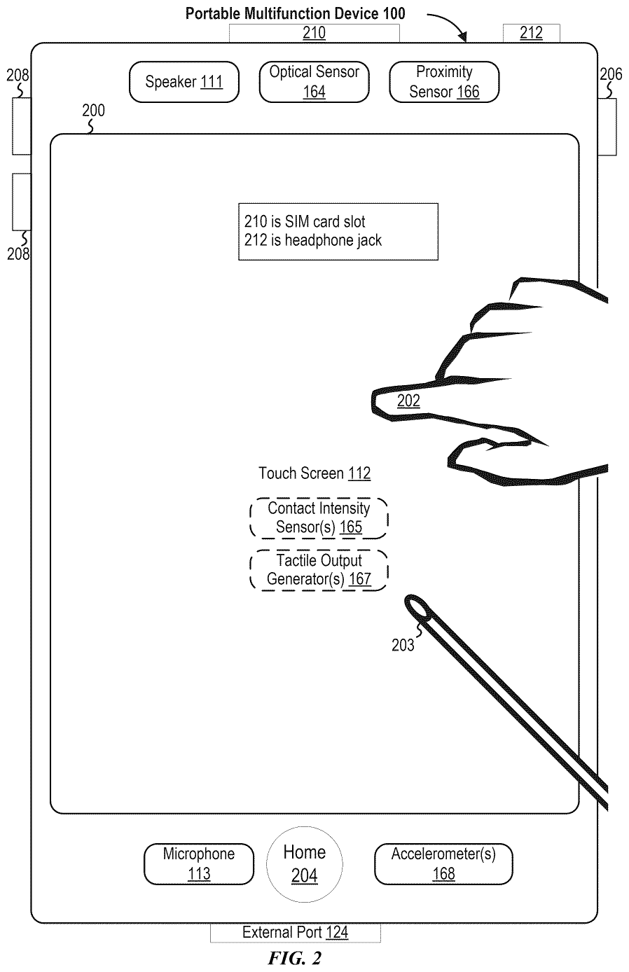

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

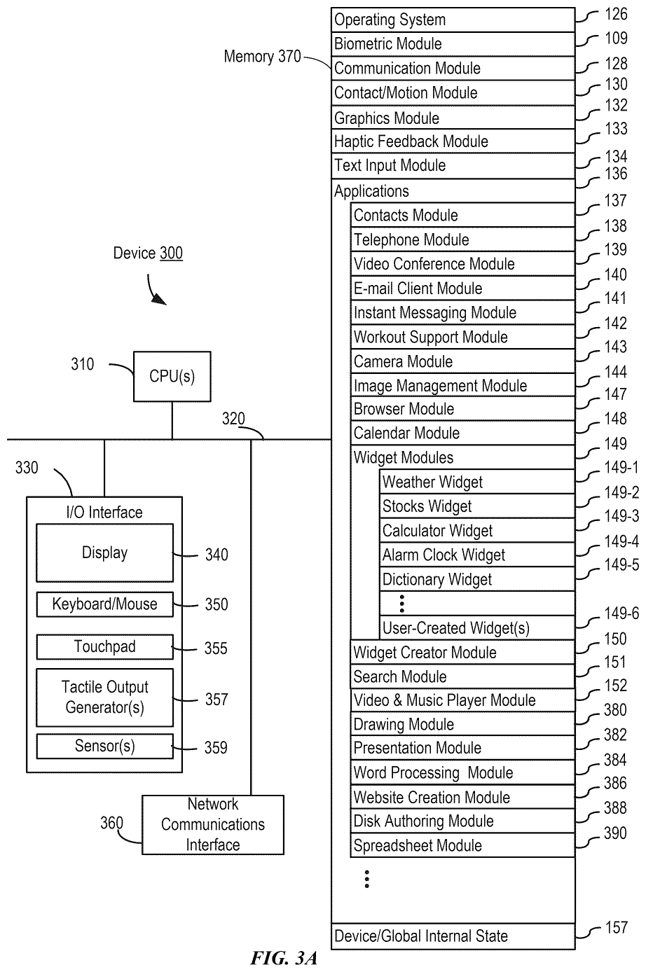

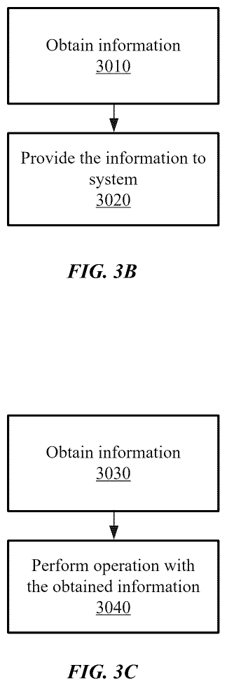

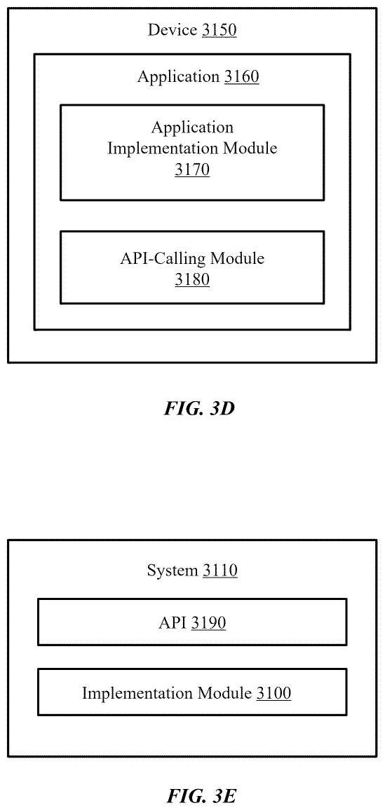

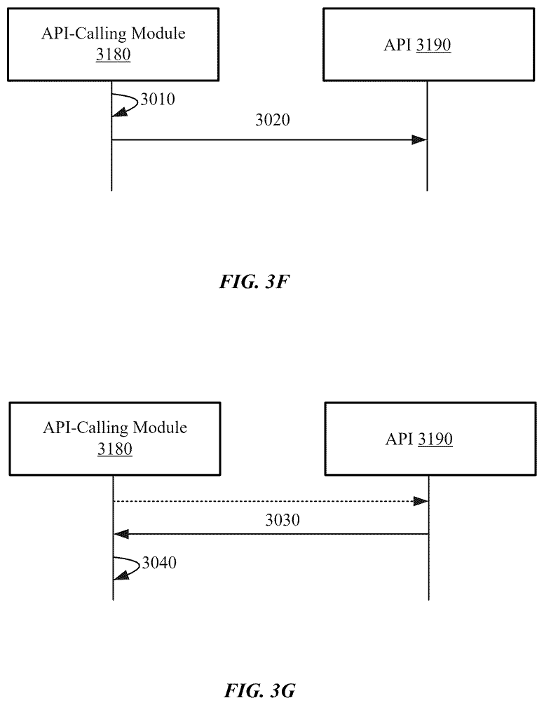

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 and/or 800 (FIGS. 7 and/or 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

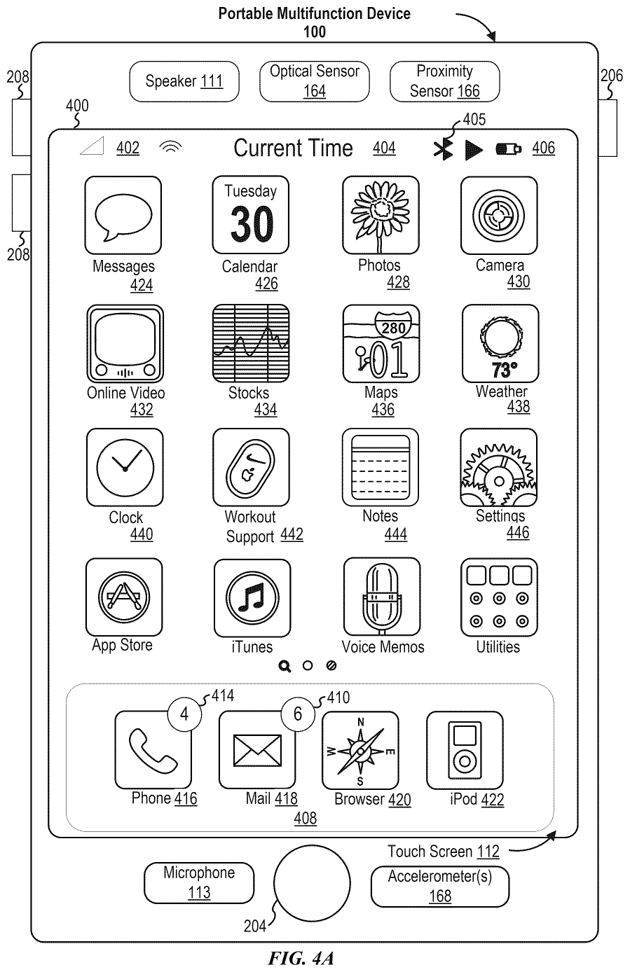

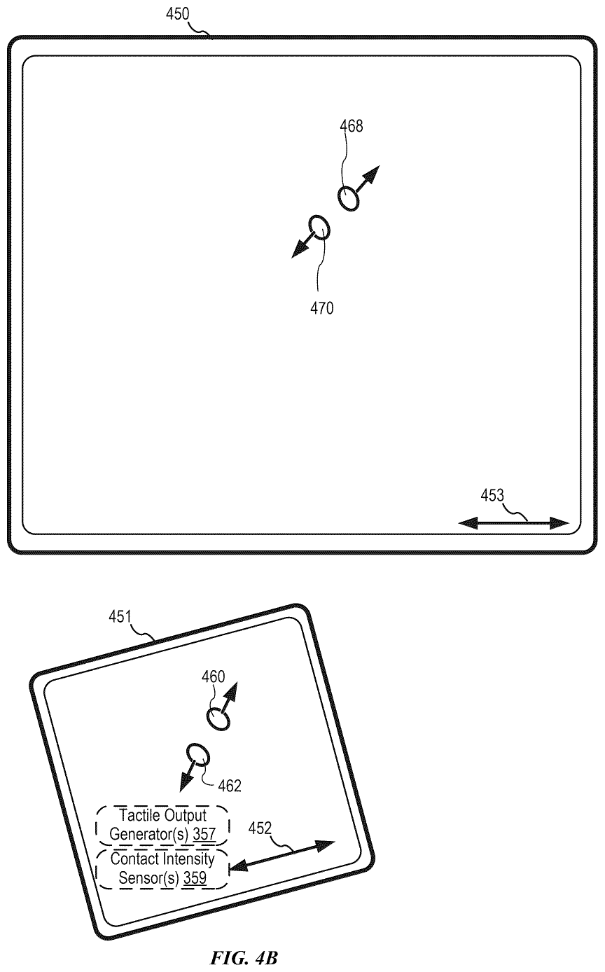

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof: Signal strength indicator(s) 402 for wireless communication(s), such as cellular and Wi-Fi signals;

Time 404;

Bluetooth indicator 405;

Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contact 460 and contact 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

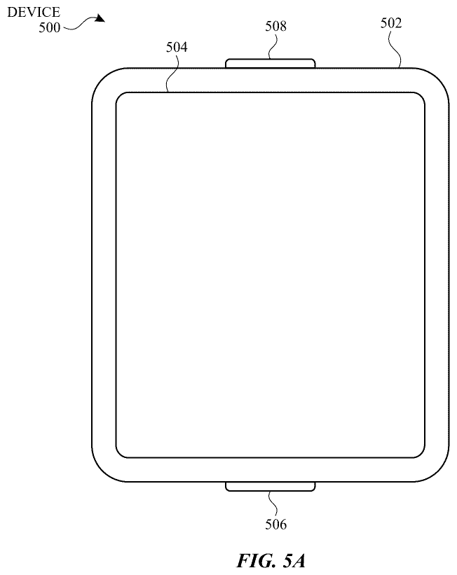

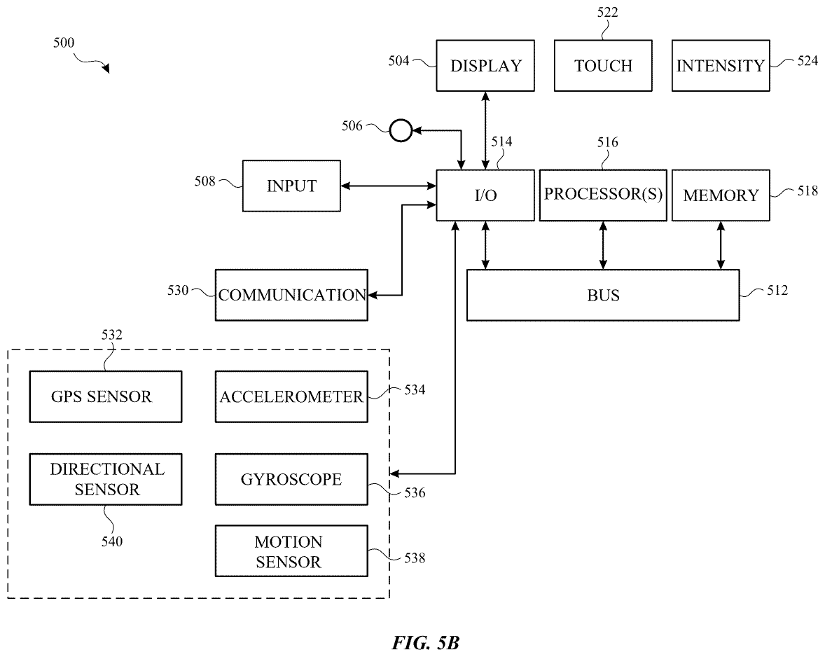

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700 and/or 800 (FIGS. 7 and/or 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6N illustrate exemplary user interfaces for providing contextual notifications, in accordance with some embodiments. The user interfaces in these FIGURES are used to illustrate the processes described below, including the processes in FIGS. 7 and 8.

FIG. 6A illustrates computer system 600, which includes display 602 (e.g., a touch-sensitive display), rotatable and depressible input mechanism 604, and button 606. In FIG. 6A, computer system 600 is a smartwatch (e.g., a device that operates as a wearable timekeeping device). In some embodiments, computer system 600 is a smartphone, a tablet computer, or a personal computer. In some embodiments, computer system 600 includes one or more features of device 100, device 300, and/or device 500.

At FIG. 6A, computer system 600 displays user interface 600a on display 602. In the example shown in FIG. 6A, user interface 600a includes background content 610, including indication of time 610a and portrait 610b, and weather complication 612. In some embodiments, computer system 600 displays user interface 600a in response to detecting a set of wake criteria (e.g., a set of criteria for transitioning from a lower power state to a higher power state). In some embodiments, the set of wake criteria includes a criterion that is met when a touch is detected on display 602, when an input is received on rotatable and depressible input mechanism 604 and/or button 606, when data is received (e.g., data for an incoming message or other data relating to a notification), and/or when a wrist raise gesture is detected (e.g., computer system 600 is moved in a manner indicative of computer system 600 being raised into a viewing position).

In some embodiments, computer system 600 displays user interface 600a in response to detecting an input while displaying a different user interface, such as a widget stack user interface (e.g., user interface 600b), an application user interface (e.g., user interface 600e and/or user interface 600i), a notification user interface (e.g., user interface 600h), a home screen, and/or an application-launching user interface. For example, in some embodiments, the input that is detected while displaying the other user interface is a touch (e.g., tap, swipe, and/or press and hold) detected on display 602, rotation of rotatable and depressible input mechanism 604, depression of rotatable and depressible input mechanism 604, and/or depression of button 606.

In some embodiments, a set of widgets, such as widget stack 620, is available to be displayed by computer system 600. In the example shown in FIG. 6A, computer system 600 is not actively displaying widget stack 620, but rather FIG. 6A depicts the widget stack that corresponds to user interface 600a. In some embodiments, widget stack 620 includes several individual widgets, such as top widget 620a, middle widget 620b, and bottom widget 620c, as shown in the widget stack below computer system 600 in FIG. 6A. In some embodiments, the widgets provide status indicators, alerts, and/or other notifications, such as information regarding potentially relevant information (e.g., current weather conditions), an ongoing activity (e.g., time remaining on a timer), a recently accessed application (e.g., a wallet application), and/or progress toward a goal (e.g., a daily movement goal).

In some embodiments, computer system 600 displays widget stack 620 in response to receiving an input on user interface 600a. For example, in response to detecting upward swipe input 650 and/or upward rotation input 652, computer system 600 displays widget stack 620 in user interface 600b. As shown in FIG. 6B, user interface 600b includes background content 610, including date 610c and time 610d, and widget stack 620, including top widget 620a, middle widget 620b, and bottom widget 620c. In the example shown in FIG. 6B, top widget 620a includes current weather conditions for the location of computer system 600. In some embodiments, computer system 600 returns to displaying user interface 600a in response to detecting downward swipe input 654 and/or downward rotation input 656 while displaying user interface 600b.

In some embodiments, computer system 600 displays a contextual notification that provides a user of computer system 600 with an efficient way to view and access relevant information and/or application controls based on the context of computer system 600. For example, in some embodiments, computer system 600 displays contextual notification 624. As illustrated in FIG. 6C, in some embodiments, contextual notification 624 includes a graphical indication. For example, as shown in FIG. 6C, contextual notification 624 includes a tracking icon (e.g., depicted by the curved line with a dot on one end and an arrow on the other end) that corresponds to a compass application with the ability to track a hike (e.g., by tracking the location and/or movement of computer system 600).

In some embodiments, contextual notification 624 is displayed in user interface 600c in a subtle manner that is intended to provide the user with access to relevant information without creating a significant distraction. In some embodiments, contextual notification 624 is overlaid on other content in the user interface. For example, as shown in FIG. 6C, contextual notification 624 is overlaid on background content 610. In some embodiments, contextual notification 624 appears in user interface 600c without a corresponding audio and/or haptic indicator. In some embodiments, contextual notification 624 includes a simulated lighting effect (e.g., in order to silently direct attention of the user to contextual notification 624 while the user is viewing user interface 600c). For example, in some embodiments, contextual notification 624 appears to shimmer, emit light (e.g., a simulated glow), and/or cast light onto background content 610.

In the example shown in FIG. 6C, contextual notification 624 corresponds to a compass application and/or a tracking function (e.g., so a user can record and retrace a hiking route to avoid getting lost). In some embodiments, computer system 600 determines a confidence level (e.g., as discussed in more detail below) that a user of the computer system is hiking based on the location of computer system 600 (e.g., in a remote area, rather than a populated area) and/or movement of computer system 600 (e.g., based on a rate of change in location of computer system 600), as discussed in more detail with respect to FIG. 6K.

In some embodiments, computer system 600 is displaying user interface 600a, as shown in FIG. 6A, when computer system 600 detects a change in context. In some embodiments, in response to detecting the change in context, computer system 600 changes from displaying user interface 600a, which does not include contextual notification 624, to displaying user interface 600c, which includes contextual notification 624 (or vice versa). In FIG. 6C, for example, computer system 600 determines that it is likely that a user of computer system 600 is hiking in a remote area and computer system 600 displays contextual notification 624.

As shown in FIG. 6C, contextual notification 624 is displayed with (and optionally overlaid on a portion of) content that was already being displayed (e.g., background content 610, including indication of time 610a and portrait 610b). In some embodiments, computer system 600 is displaying a user interface other than user interface 600a (e.g., user interface 600i) when computer system 600 detects the change in context, and computer system 600 displays contextual notification 624 alongside the content of the other user interface (e.g., in FIG. 6I, contextual notification 624 is overlaid on the content of user interface 600i).

In some embodiments, prior to displaying contextual notification 624, computer system 600 is in a lower power state. In some embodiments, when computer system 600 is in the lower power state, computer system 600 does not display anything on display 602. In some embodiments, when computer system 600 is in the lower power state, computer system 600 displays a lower-power user interface (e.g., a user interface with reduced and/or minimal content and/or lower brightness). In some embodiments, computer system 600 displays user interface 600c, including contextual notification 624, in response to detecting a set of wake criteria (e.g., as discussed above with respect to displaying user interface 600a) while in the lower power state. In this example, contextual notification 624 and background content 610 are displayed at the same time in response to detecting the wake criteria and based on a determination regarding the context of computer system 600 (e.g., at the time the wake criteria is detected).

As shown in FIG. 6C, a set of widgets is available to be displayed by computer system 600, similar to as shown in FIG. 6A. However, in some embodiments, top widget 620a corresponds to contextual notification 624, as shown in FIG. 6C. In some embodiments, the widget corresponding to contextual notification 624 provides additional information regarding contextual notification 624 and/or controls for an application corresponding to contextual notification 624. For example, in FIG. 6C, top widget 620a includes information regarding tracking a hiking route using a compass application, including tracking icon 626 for initiating tracking a hiking route.

In some embodiments, in response to receiving an upward swipe input (e.g., similar to upward swipe input 650 shown in FIG. 6A) and/or an upward rotation input (e.g., similar to upward rotation input 652 shown in FIG. 6A), computer system 600 displays user interface 600d, including widget stack 620, as shown in FIG. 6D. In some embodiments, computer system 600 (e.g., additionally or alternatively) displays user interface 600d in response to detecting an interaction with contextual notification 624. For example, in some embodiments, computer system 600 displays user interface 600d in response to detecting tap input 658 (FIG. 6C) directed toward contextual notification 624.

In some embodiments, computer system 600 provides access to a corresponding application in response to detecting a tap on a widget (e.g., in widget stack 620). For example, computer system 600 displays user interface 600e of the compass application, as shown in FIG. 6E, in response to detecting tap input 666 directed toward top widget 620a shown in FIG. 6D. In some embodiments, the corresponding application interface contains additional information and/or controls that allow a user to perform various functions. For example, as shown in user interface 600e of FIG. 6E, computer system 600 displays the current orientation of computer system 600 on a compass, additional coordinate and elevation information, and an option for saving a particular location. Additionally, as shown in user interface 600e, recording a hike can be manually initiated in response to detection of tap input 668 on tracking icon 626. In some embodiments, computer system 600 returns to a previous user interface (e.g., user interface 600c or user interface 600d) in response to detecting depression input 669 on rotatable and depressible input mechanism 604.

In some embodiments, in response to detecting tap input 668 (FIG. 6E) directed toward tracking icon 626 in user interface 600e, computer system 600 displays user interface 600f shown in FIG. 6F. In some embodiments, tracking icon 626 shown in user interface 600e in FIG. 6E changes appearance in user interface 600f in FIG. 6F to indicate that the tracking function is in progress. In some embodiments, computer system 600 transitions from displaying user interface 600f in FIG. 6F to displaying user interface 600g in FIG. 6G (e.g., a modified version of previous user interface 600d, indicating that a hiking route is being recorded) in response to detecting depression input 670 on rotatable and depressible input mechanism 604.

In some embodiments, computer system 600 directly initiates an action in response to receiving a tap on a button or other graphical user interface object. For example, computer system 600 displays tracking icon 626 as part of top widget 620a in user interface 600d, as shown in FIG. 6D. In some embodiments, in response to detecting tap input 667 directed toward tracking icon 626 shown in FIG. 6D, computer system 600 initiates the tracking feature and displays user interface 600g shown in FIG. 6G.

In some embodiments, computer system 600 initiates an action in response to detecting an interaction with contextual notification 624 (e.g., in addition to or rather than showing information corresponding to contextual notification 624 in a widget). For example, in some embodiments, in response to detecting tap input 658 shown in FIG. 6C, computer system 600 initiates the hike tracking function. In some embodiments, in response to detecting tap input 658, computer system 600 initiates the hike tracking function and continues displaying user interface 600c, as shown in FIG. 6C. In some embodiments, in response to detecting tap input 658, computer system 600 initiates the hike tracking function and displays user interface 600f, as shown in FIG. 6F. In some embodiments, in response to detecting tap input 658, computer system 600 initiates the hike tracking function and displays user interface 600g, as shown in FIG. 6G.

In some embodiments, computer system 600 displays an indicator when a notification is available to be displayed. For example, as shown in FIG. 6C, user interface 600c includes notification indicator 622. In some embodiments, the notifications associated with notification indicator 622 include time-sensitive notifications, such as an alert, an upcoming meeting, a recent push notification, and/or a recently received message, email, or call. In some embodiments, computer system 600 provides an audio and/or haptic indication when displaying notification indicator 622 (e.g., unlike contextual notification 624, which is provided without an audio and/or haptic indication in some embodiments).

In some embodiments, computer system 600 displays a notification user interface in response to detecting an input directed toward notification indicator 622. For example, computer system 600 displays user interface 600h shown in FIG. 6H in response to detecting downward swipe input 664 shown in FIG. 6C. As illustrated in FIG. 6H, the notification user interface includes various notifications, such as loud environment alert 630 and meeting notification 632. In some embodiments, computer system 600 continues to display contextual notification 624 after switching to a different user interface. For example, computer system 600 displays contextual notification 624 in user interface 600h and user interface 600i (e.g., while notification indicator 622 is optionally not displayed). In some embodiments, contextual notification 624 is overlaid on content of the other user interface. For example, contextual notification 624 is overlaid on meeting notification 632 in user interface 600h and weather information 634 in user interface 600i.

In some embodiments, computer system 600 detects an input corresponding to content other than contextual notification 624. For example, as shown in FIG. 6C, computer system 600 detects tap input 662 directed toward weather complication 612. In some embodiments, in response to detecting tap input 662, computer system 600 displays a user interface for a corresponding weather application, such as user interface 600i shown in FIG. 6I. As mentioned above, in some embodiments, computer system 600 continues to display contextual notification 624 after switching to a different user interface. For example, computer system 600 displays contextual notification 624 in user interface 600i. In this example, contextual notification 624 is overlaid on weather information 634 in user interface 600i.

In some embodiments, computer system 600 continues displaying contextual notification 624 when changing between displaying a home screen (e.g., user interface 600c), an application user interface (e.g., user interface 600i), and/or a notification user interface (e.g., user interface 600h). In some embodiments, contextual notification 624 is not displayed in a user interface that includes widget stack 620 because information regarding contextual notification 624 is displayed in one of the widgets. In some embodiments, contextual notification 624 is not displayed in one or more types of user interfaces in order to better enable a user to view information. For example, in some embodiments, contextual notification 624 is not displayed in a notification user interface (e.g., user interface 600h) in order to better facilitate viewing notifications for the user. In some embodiments, computer system 620 continues displaying contextual notification 624 as long as it remains relevant (e.g., as determined based on the confidence level).

In some embodiments, computer system 600 displays contextual notification 624 for a predetermined duration and/or until a predetermined number of instances of the wake criteria have been detected (e.g., until time out criteria for contextual notification 624 have been met), even if contextual notification 624 remains relevant (e.g., as determined based on the confidence level). In some embodiments, after the predetermined duration has ended and/or the predetermined number of instances of the wake criteria have been detected, computer system 600 dismisses contextual notification 624 (e.g., ceases to display contextual notification 624).

For example, in some embodiments, computer system 600 displays contextual notification 624 as shown in user interface 600c in FIG. 6C for the predetermined duration (e.g., 5 minutes) and, after the predetermined duration has passed, computer system 600 ceases displaying contextual notification 624, as shown in user interface 600j in FIG. 6J. In some embodiments, computer system 600 displays contextual notification 624, as shown in user interface 600c in FIG. 6C, each instance that the wake criteria are detected (e.g., the first three times the wake criteria are detected) within a given period of time (e.g., a day or a week), until the predetermined number (e.g., three) of instances of the wake criteria have been detected. In some embodiments, the subsequent instance (e.g., the fourth instance) that the wake criteria are detected, computer system 600 does not display contextual notification 624, as shown in user interface 600j in FIG. 6J (e.g., until the given period of time (e.g., until the next day or next week)).

In some embodiments, a user of computer system 600 can dismiss contextual notification 624 so it is no longer displayed in the user interface. For example, as shown in FIG. 6C, computer system 600 detects downward swipe input 660 and/or downward rotation input 661. In some embodiments, in response to detecting downward swipe input 660 and/or downward rotation input 661, computer system 600 does not display contextual notification 624, as shown in user interface 600j in FIG. 6J.

In some embodiments, after the time out criteria for contextual notification 624 have been met and/or contextual notification 624 is dismissed by a user, computer system 600 suppresses contextual notification 624 for a period of time, even if contextual notification 624 is determined to be relevant (e.g., as determined based on the confidence level). For example, after contextual notification 624 has timed out and/or has been dismissed based on detected input from a user, computer system 600 will continue displaying user interface 600j (and/or other user interfaces that do not include contextual notification 624) for the period of time. In some embodiments, computer system 600 suppresses contextual notification 624 for a longer period of time in response to detecting an input that corresponds to dismissal of contextual notification 624 as compared with the amount of time when the time out criteria have been met.

In some embodiments, even if contextual notification 624 times out and/or is dismissed, computer system 600 continues to display information corresponding to the contextual notification in top widget 620a when displaying widget stack 620. For example, as shown in FIG. 6J, user interface 600j does not include contextual notification 624, but corresponding widget stack 620 includes tracking information in top widget 620a. In this example, in response to swipe up input 674 and/or upward rotation input 675, computer system 600 displays user interface 600d shown in FIG. 6D, which includes the tracking information in top widget 620a.

In some embodiments, whether computer system 600 displays contextual notification 624, displays information relating to contextual notification 624 (e.g., in top widget 620a of widget stack 620), and/or performs an action (e.g., initiates a process for recording a hike) depends on the confidence level regarding the context of computer system 600. In some embodiments, the same input (e.g., a set of wake criteria) results in various different outcomes based on the determined confidence level (e.g., confidence level 690), as illustrated in FIG. 6K.

In some embodiments, computer system 600 does not display contextual notification 624 or information relating to contextual notification 624. As shown on the left side of FIG. 6K, in some embodiments, computer system 600 determines that there is no certainty (or, in some embodiments, certainty below a threshold level (e.g., 5% or 10%) of certainty, indicating very low certainty) that contextual notification 624 is relevant. For example, when computer system 600 is stationary and/or located in a populated area (e.g., as illustrated by the map in the lower left in FIG. 6K), computer system 600 determines that the hike tracking contextual notification is probably not relevant to a user of computer system 600 and computer system 600 does not display information pertaining to tracking a hike in user interface 600k1.

In some embodiments, computer system 600 displays information relating to contextual notification 624 in widget stack 620 in response to detecting a request to display widget stack 620. As shown in the middle left side of FIG. 6K, in some embodiments, computer system 600 determines that there is low certainty that contextual notification 624 is relevant. For example, when computer system 600 has moved a small distance (e.g., 3 steps) and/or is moving in a populated area (e.g., as illustrated by the map in the middle left in FIG. 6K), computer system 600 determines that there is a small chance (e.g., certainty greater than a first threshold level (e.g., 5% or 10%) but less than a second threshold level (e.g., 10% or 25%) of certainty) that a user of computer system 600 would like to track a hike. In this example, computer system 600 does not display information relating to contextual notification 624 in user interface 600k2. However, in this example, computer system 600 displays information relating to tracking a hike in widget stack 620 in response to detecting a user input corresponding to a request to display widget stack 620 (e.g., upward swipe input 650 and/or upward rotation input 652, shown in FIG. 6A).

In some embodiments, computer system 600 displays contextual notification 624 in a home user interface and/or application user interface (and optionally overlaid on content of the user interface). As shown in the center of FIG. 6K, in some embodiments, computer system 600 determines that there is medium certainty (e.g., certainty greater than a second threshold (e.g., 10% or 25%) but less than a third threshold level of certainty (e.g., 50% or 75%)) that contextual notification 624 is relevant to a user of computer system 600. For example, when computer system 600 has moved a short distance (e.g., 5, 10, or 15 steps) in a remote area (e.g., as illustrated by the map in the center of FIG. 6K), computer system 600 determines that the hike tracking contextual notification is likely relevant to a user of computer system 600 and computer system 600 displays contextual notification 624 in user interface 600k3.

In some embodiments, computer system 600 displays information relating to contextual notification 624 in widget stack 620 in response to detecting a request to display a user interface (e.g., in response to detecting wake criteria). As shown in the middle right of FIG. 6K, in some embodiments, computer system 600 determines that there is a high certainty that contextual notification 624 is relevant to a user of computer system 600. For example, when computer system 600 has moved a medium distance (e.g., 10, 20, or 30 steps) in a remote area (e.g., as illustrated by the map in the middle right of FIG. 6K), computer system 600 determines that the hike tracking contextual notification is probably relevant to a user of computer system 600 and computer system 600 displays information regarding contextual notification 624 in widget stack 620, as shown in user interface 600k4. In this case, computer system 600 displays user interface 600f in response to detecting tap input 676 on top widget 620a.

In some embodiments, computer system 600 performs an action relating to contextual notification 624. As shown on the right of FIG. 6K, in some embodiments, computer system 600 determines that there is a very high certainty (e.g., certainty greater than a third threshold level (e.g., 90% or 95%) of certainty) that contextual notification 624 is relevant to a user of computer system 600. For example, when computer system 600 has moved a far distance (e.g., 20, 40, or 60 steps) in a remote area (e.g., as illustrated by the map in the right of FIG. 6K), computer system 600 determines that the hike tracking contextual notification is almost certainly relevant to a user of computer system 600 and computer system 600 initiates the process for tracking a hike, as shown in user interface 600k5. In this case, computer system 600 displays user interface 600g in response to tap input 678 on top widget 620a.

In some embodiments, the contextual notification is displayed based on user activity and/or movement of computer system 600. For example, as shown in FIG. 6K and discussed in more detail above, contextual notification 624 corresponds to tracking a hike, and computer system 600 displays contextual notification 624 based on movement of computer system 600 (e.g., in a remote area and/or an area that is a threshold distance from residential and/or commercial developments, such as a hiking trail and/or national forest). The various inputs for navigating between user interfaces and for controlling functions of computer system 600 that are shown and discussed above with respect to FIGS. 6A through 6J also apply to the user interface shown in FIG. 6K.

In some embodiments, contextual notification 624 is displayed based on the time of day and/or a typical routine of the user of computer system 600. For example, as shown in FIG. 6L, contextual notification 624 corresponds to a reminder to log a medication, and computer system 600 displays contextual notification 624 based on the time of day and the time the user is scheduled to take the medication. As illustrated in FIG. 6L, a reminder to log a medication has been set for 10:00 AM.

In this example, at 8:00 AM, computer system 600 determines that there is no certainty (or, in some embodiments, very low certainty) that a user of computer system 600 would want to log the medication at that time. Accordingly, as shown on the left of FIG. 6L, computer system 600 does not display contextual notification 624 or information pertaining to contextual notification 624 in user interface 60011. At 9:30 AM, computer system 600 determines that there is a small chance that a user of computer system 600 would want to log the medication at that time. Accordingly, as shown in the middle left of FIG. 6L, computer system 600 does not display contextual notification 624 in user interface 60012, but information relating to contextual notification 624 is available to the user in response to detecting a request to view widget stack 620 (e.g., as discussed above with respect to FIG. 6A).

In this example, at 9:55 AM, computer system 600 determines that it is likely that a user of computer system 600 would want to log the medication at that time. Accordingly, as shown in the center of FIG. 6L, computer system 600 displays contextual notification 624 in user interface 60013. At 10:00 AM, computer system 600 determines that a user of computer system 600 probably wants to log the medication at that time. Accordingly, as shown in the middle right of FIG. 6L, computer system 600 displays information relating to contextual notification 624 in widget stack 620 (e.g., upon detecting a set of wake criteria).

In this example, computer system 600 does not automatically take an action regarding logging a medication. In some embodiments, computer system 600 only performs an action in response to detecting a corresponding user input. For example, computer system 600 only logs a medicine in response to detecting a user input indicating that the medication should be logged. Similar inputs for navigating between user interfaces and for controlling functions of computer system 600 as those shown and discussed above with respect to FIGS. 6A and 6J also apply to the user interfaces shown in FIG. 6L. For example, computer system 600 displays a user interface for a health and/or medications application in response to detecting tap input 680 directed toward top widget 620a with information relating to logging a medication in user interface 60013.

In some embodiments, the contextual notification is displayed based on the location of computer system 600. For example, as shown in FIG. 6M, contextual notification 624 corresponds to an air quality alert, and computer system 600 displays contextual notification based on the air quality conditions at the location of computer system 600.

In this example, when the air quality index (AQI) is in a good range (e.g., 0-50 AQI), computer system 600 determines that there is no certainty that a user of computer system 600 would want to view an air quality alert. Accordingly, as shown on the left of FIG. 6M, computer system 600 does not display contextual notification 624 or information pertaining to contextual notification 624 in user interface 600m1. When the air quality index is moderate (e.g., 50-150 AQI), computer system 600 determines that there is a small chance that a user of computer system 600 would want to view an air quality alert. Accordingly, as shown in the middle left of FIG. 6M, computer system 600 does not display contextual notification 624 in user interface 600m2, but information relating to contextual notification 624 is available to the user in response to detecting a request to view widget stack 620 (e.g., as discussed above with respect to FIG. 6A).

In this example, when the air quality index is unhealthy (e.g., between 151-200 AQI), computer system 600 determines that it is likely that a user of computer system 600 would want to view an air quality alert. Accordingly, as shown in the middle right of FIG. 6M, computer system 600 displays information relating to contextual notification 624 in widget stack 620 (e.g., upon detecting a set of wake criteria).

In this example, computer system 600 does not automatically take an action regarding the air quality alert. In some embodiments, there is no action corresponding to contextual notification 624. For example, in the example shown in FIG. 6M, there is no action corresponding to the air quality alert. Similar inputs for navigating between user interfaces and for controlling functions of computer system 600 as those shown and discussed above with respect to FIGS. 6A and 6J also apply to the user interfaces shown in FIG. 6M. For example, computer system 600 displays a user interface of a weather application in response to detecting tap input 682 directed to top widget 620a with information relating to the air quality alert in user interface 600m4.

In some embodiments, the contextual notification is displayed based on ambient conditions (e.g., in the environment surrounding computer system 600). For example, as shown in FIG. 6N, contextual notification 624 corresponds to a flashlight control, and computer system 600 displays contextual notification 624 based on the lighting conditions in the environment surrounding computer system 600.

In this example, when computer system 600 is in daylight conditions (e.g., 500 lux), computer system 600 determines that there is no certainty (or, in some embodiments, very low certainty) that a user of computer system 600 would want to access the flashlight function. Accordingly, as shown on the left of FIG. 6N, computer system 600 does not display contextual notification 624 or information pertaining to contextual notification 624 in user interface 600n1. When computer system 600 is in twilight conditions (e.g., 10 lux), computer system 600 determines that there is a small chance that a user of computer system 600 would want to access the flashlight function. Accordingly, as shown in the middle left of FIG. 6N, computer system 600 does not display contextual notification 624 in user interface 600n2, but information relating to contextual notification 624 is available to the user in response to detecting a request to view widget stack 620 (e.g., as discussed above with respect to FIG. 6A).

In this example, when computer system 600 is in dusk conditions (e.g., 5 lux), computer system 600 determines that it is likely that a user of computer system 600 would want to access the flashlight function. Accordingly, as shown in the center of FIG. 6N, computer system 600 displays contextual notification 624 in user interface 600n3. When computer system 600 is in night conditions (e.g., 1 lux), computer system 600 determines that a user of computer system 600 probably wants to access a flashlight function. Accordingly, as shown in the middle right of FIG. 6N, computer system 600 displays information relating to contextual notification 624 in widget stack 620 (e.g., upon detecting a set of wake criteria).

In some embodiments, computer system 600 automatically performs an action based on a combination of conditions being met. For example, as illustrated by the right side of FIG. 6N, when computer system 600 is in night conditions (e.g., 1 lux) and computer system 600 detects a particular orientation (e.g., raised and/or oriented away from a user), computer system 600 automatically turns on a flashlight function. Similar inputs for navigating between user interfaces and for controlling functions of computer system 600 as those shown and discussed above with respect to FIGS. 6A and 6J also apply to FIG. 6N. For example, computer system 600 displays a flashlight user interface in response to detecting tap input 684 directed toward top widget 620a with information relating to the flashlight function in user interface 600n4.

In some embodiments, computer system 600 displays contextual notification 624 and/or information corresponding to contextual notification 624 based on a variety of possible conditions. In some embodiments, contextual notification 624 and/or information corresponding to contextual notification 624 relates to a variety of possible applications and/or possible actions. For example, the table below includes different combinations of applications, actions, and corresponding conditions for displaying contextual notification 624 and/or information corresponding to contextual notification 624.

| | | Condition(s) for | Condition(s) for |
|---|---|---|---|
| | | Displaying Contextual | Displaying Contextual |
| | | Notification in a | Notification Overlaid |
| | Contextual | Plurality of Selectable | on Content of User |
| Application | Notification | User Interface Objects | Interface |
| Flashlight | Flashlight | Ambient light sensor | Ambient light sensor |
| | | detects darkness + | detects darkness + |
| | | Display is Active | Display is Active |
| Workout | Workout | Similar time (day of week | Time (day of week and |
| | Routine | and time of day) and/or | time of day) and/or |
| | Suggestion | place of a workout of a | place of a workout of |
| | | particular type, but not | a particular type |
| | | completely consistent with | |
| | | pattern or not the precise | |
| | | time/place | |
| Camera | Camera Remote | User launches Camera app on | |
| | | companion device (e.g., phone) | |
| | | and raises wrist | |
| Settings | Captive WiFi | Public WiFi available, no | |
| | | connectivity (e.g., no nearby | |
| | | companion device or phone, no | |
| | | cellular connection) | |
| Compass | Start recording | At a remote location for a | |
| | hiking route | period of time | |
| Messaging | Messaging | Extended time in remote | |
| | Connection | location, satellite availability, | |
| | Assistant | messaging-specific logic | |
| Finding | Finding | Extended time in remote | |
| App | Connection | location, satellite availability, | |
| | Assistant | finding-specific logic | |
| Control | Airplane Mode | Around boarding time denoted | Indication(s) that user |
| Center | | by a calendar event or boarding | boarded plane |
| | | pass | |
| Control | Do Not Disturb | Calendar event is currently | Indication(s) that user |
| Center | | beginning (e.g., certain types | does not want to be |
| | | of events only) | disturbed (e.g., in a |
| | | | meeting) |
| Reminders | Time-Based | Task due today and incomplete | A particular reminder is |
| | Reminders | (e.g., separate selectable user | relevant (e.g., based on |
| | | interface object for each task) | location and/or time of |
| | | | day) |
| Reminders | Location-Based | Open task with a nearby | A particular reminder is |
| | Reminders | location (e.g., separate | relevant (e.g., based on |
| | | selectable user interface | location and/or time of |
| | | object for each task) | day) |
| Reminders | Shopping List | At a grocery store or other | A particular shopping list |
| | | food market | item is relevant (e.g., |
| | | | based on location and/or |
| | | | time of day) |
| Weather | Travel Weather | Calendar events suggest | |
| | | upcoming travel to another | |
| | | city (e.g., show the weather | |
| | | for that city) | |
| Cycle | Period | 5-7 days before prediction | |
| Tracking | Prediction | | |
| Workout | Workout | Active workout | |
| World | Sunset | Before, during and after | |
| Clock | | sunrise/sunset (e.g., | |
| | | approximately 15 min) | |
| Weather | Precipitation | Rain in the next hour | |
| Tides | Current Location | Near a beach (e.g., as | |
| | | determined by location points | |
| | | of interest (POIs)) and within | |
| | | 4 km of a saved static location | |
| Wallet | Wallet/ | A specific pass is relevant | |
| | Boarding Pass | based on time, location, and/ | |
| | | or Bluetooth signal | |
| Workout | Suggest short | Workout goal is not complete | |
| | walk to complete | near the typical end of the | |
| | workout goal | day, but can be completed with | |
| | | a short walk | |
| Maps | Notable POIs | At a transit station (e.g., | |
| | | based on live departure times), | |
| | | at a landmark (e.g., based on | |
| | | landmark information) | |
| Maps | Traffic | Leaving work for home, leaving | Indication(s) of leaving |
| | Conditions | home for work | home/work paired with |
| | Home/Work | | an indication of routine |
| Now | Nearby Speaker | Audio playing on a nearby | |
| Playing | Control | speaker (e.g., a smart speaker) | |
| Weather | Severe weather | Severe weather warning active | |
| Music | Identify Music | Ambient music is detected in | |
| Detection | | the environment | |
| Home | Suggested | Home accessory available with | Currently in a particular |
| | Controls | indication(s) of relevance based | room (e.g., based on |
| | | on user location (e.g., home or | microlocation information) |
| | | away), user activity (e.g., | |
| | | walking, running, arrived home, | |
| | | departed home), state of | |
| | | accessory(ies), and/or routine | |
| | | (e.g., bedtime, wakeup) | |
| | | (optionally, if no specific | |
| | | action is warranted (e.g., lock | |
| | | all), home summary is displayed) | |
| Activity | Distance this | After user finishes a workout of | |
| | Week | a particular type (e.g., display | |
| | | weekly workout distance for the | |
| | | hour following the completed | |
| | | workout) | |
| Activity | Steps Distance | End of day, bedtime | |
| Activity | Distance this | After user has completed at | |
| | Month | least 3 workouts of a particular | |
| | | type (e.g., display monthly | |
| | | workout distance for the hour | |
| | | following the completed | |
| | | workout) | |
| Activity | Training Load | In the morning after waking up, | |
| | | within 30 minutes of doing a | |
| | | workout (e.g., if user opted-in | |
| | | to post-workout effort rating) | |
| Audiobooks | Suggested Book | Workout active, headphones | |
| | (Recents) | connected, at a specific time | |
| | | of day (e.g., a time when the | |
| | | user typically commutes or goes | |
| | | to bed), and/or user played | |
| | | audiobook within last 21 days | |
| Cycle | Log Cycle | Near wakeup/bedtime on | |
| Tracking | | predicted day that has not yet | |
| | | been logged or while pregnancy | |
| | | cycle is ongoing (optionally | |
| | | include gestational age for | |
| | | pregnancy cycle) | |
| Heartrate | Post workout | After workout | |
| | heartrate | | |
| Messages | Check In | Active workout without an | |
| | | ongoing location-sharing | |
| | | session in progress | |
| Photos | Featured | Fallback suggestion (when there | |
| | | is room in the plurality of | |
| | | selectable user interface objects) | |
| Stocks | Market | Stocks identified on watch list, | |
| | Open/Close | between market close and one | |
| | | hour after market close, | |
| | | between market open and one | |
| | | hour after market open | |
| Translate | Translate | In a country with a language | Talking is detected |
| | | different than the device | |
| | | language | |
| Health | Overnight | Between end of last sleep | |
| Statistics | Metrics - Vitals | sample and 72 minutes after last | |
| App | | sleep cycle ended (e.g., within | |
| | | 72 minutes of user waking up), | |
| | | threshold amount of data | |
| | | collected | |
| Health | Overnight | Between end of last sleep | |
| Statistics | Metrics - Week | sample and 72 minutes after last | |
| App | View | sleep cycle ended (e.g., within | |
| | | 72 minutes of user waking up), | |
| | | threshold amount of data | |
| | | collected | |
| Voice | Voice Memo | Active recording | |
| Memo | | | |
| Weather | Condition | Start of day, after wake up | |
| Weather | Ultraviolet Index | High UVI | |
| | (UVI) | | |
| Now | Suggested | Nearby audio device (e.g., | |
| Playing | | proximate to a speaker) that is | |
| | | not playing media | |
| Now | Suggested | Headphones connected | |
| Playing | | | |
| Medications | Medications | Oldest unlogged dose of the day | |
| | Reminder | (either the oldest missed dose | |
| | | or the next upcoming scheduled | |
| | | dose, if all previous doses are | |
| | | logged) | |
| Compass | Recording | Active session to navigate back | |
| | Hiking Route | to a starting location | |
| Activity | Activity Goals | Incomplete bedtime and/or | |
| | | activity goals for the day or | |
| | | after a user finished any | |
| | | workout | |
| Alarms | Alarm Firing | The time of the alarm | |
| Calendar | Up Next | Upcoming events for the day | |
| | | and/or within the next 8 hours | |
| | | (e.g., separate selectable user | |
| | | interface objects for each event) | |
| Mindfulness | Mindfulness | Beginning of day (e.g., if start | |
| | | of day notifications enabled), | |
| | | end of day (e.g., if end of day | |
| | | notifications enabled) | |
| News | News | Fallback suggestion (when there | |
| | | is room in the plurality of | |
| | | selectable user interface objects) | |
| Now | Now | Active Media Playing | |
| Playing | Playing | | |
| Sleep | Data | Start of day and/or at wakeup | |
| Sleep | Schedule | End of day and/or at bedtime, | |
| | | start of day and/or at wakeup | |
| Timer | Timer | Active timer | |
| Tips | Tip | 3 days after an update or until | |
| | | the user interacts with it or | |
| | | clears it | |

FIG. 7 is a flow diagram illustrating a method for providing proactive contextual notifications using a computer system in accordance with some embodiments. Method 700 is performed at a computer system (e.g., 100, 300, 500, and/or 600, a smartwatch, a smartphone, a smartspeaker, a head-mounted device, a tablet computer, a laptop computer, and/or a desktop computer) that is in communication with one or more display generation components (e.g., 602, a display controller, a display, a touch-sensitive display system, a touchscreen, a head-mounted display, and/or a monitor). In some embodiments, the computer system is optionally in communication with one or more input devices (e.g., 602, 604, 606, a touch-sensitive surface, a touchscreen display, a rotatable input mechanism, a button, a keyboard, a mouse, a joystick, a camera sensor, a light sensor, a motion sensor, and/or a microphone). Some operations in method 700 are, optionally, combined, the orders of some operations are, optionally, changed, and some operations are, optionally, omitted.

As described below, method 700 provides an intuitive way for providing proactive contextual notifications. The method reduces the cognitive burden on a user for accessing contextual notifications, thereby creating a more efficient human-machine interface. For battery-operated computing devices, enabling a user to access contextual notifications faster and more efficiently conserves power and increases the time between battery charges.

The computer system (e.g., 600) displays (702), via the one or more display generation components (e.g., 602), in a first user interface (e.g., 600c, a time user interface, a user interface that includes a digital and/or analog indication of time, a clock face, a wake screen, and/or a home screen), a contextual notification (e.g., 624, a notification regarding an available action corresponding to the first context and/or including information corresponding to the first context). In some embodiments, the contextual notification is displayed based on a context of the computer system being a first context that meets a first set of context criteria. In some embodiments, the computer system detects, via one or more input devices (e.g., 602, 604, 606, a touch-sensitive surface, a touchscreen display, a button, a keyboard, a mouse, a joystick, a camera sensor, a light sensor, a motion sensor, and/or a microphone), that the context of the computer system is the first context. In some embodiments, in accordance with a determination that the context of the computer system is the first context, the computer system displays the contextual notification. In some embodiments, the contextual notification is associated with an action (e.g., a function or operation) that is not displayed as being available in the first user interface other than through interaction with the contextual notification (e.g., the action is for a different system function or application than system functions and/or applications that are displayed in the first user interface outside of the contextual notification). In some embodiments, the contextual notification is overlaid on (e.g., overlapping and/or partially covering) first content (e.g., 610, 612, an indication of the current time, an indication of the current date, one or more complications, a background, an image, an animation, a pattern, and/or a graphic design) of the first user interface. In some embodiments, the contextual notification is different for different contexts. In some embodiments, the contextual notification is a first contextual notification based on a first context and the contextual notification is a second contextual notification based on a second context.

In some embodiments, a context includes an element of time, such as date, time, time of day, day of the week, and/or season. In some embodiments, the context is based on the current time. In some embodiments, the context is based on a time other than the current time, such as a period of time (e.g., five minutes, an hour, a day, a week, and/or a year), a previous time, and/or a future time. In some embodiments, the context is a non-time related context. In some embodiments, the context includes location information, such as current location and/or proximity to (e.g., within a threshold range of) a person, object, external device, and/or respective location. In some embodiments, the context is a non-location related context. In some embodiments, the context includes environmental conditions, such as weather (e.g., temperature, heat index, humidity, UV index, dew point, and/or conditions, such as sunny, rainy, and/or windy) and/or lighting conditions (e.g., low light or bright light). In some embodiments, the context is a non-environmental-condition related context. In some embodiments, the context is based on occurrence of an event, such as receipt and/or transmission of data (e.g., a message, email, media item, and/or notification) from an external device, user input at the computer system, user input at a companion device, and/or activity (e.g., movement and/or motion). In some embodiments, the context is a context other than receipt of incoming data from an external device. In some embodiments, the context is based on application data that is accessible to the computer system, such as information stored in a calendar application (e.g., scheduled events and/or appointments), messaging application, email application, and/or notes application on the computer system. In some embodiments, the context is based on historical information, such as patterns of usage (e.g., user input and/or activity) and/or location (e.g., repeatedly going to a location on a particular day and/or at a particular time).

In some embodiments, after (or, in some embodiments, while) concurrently displaying the first content and the contextual notification, the computer system detects (704) that the context of the computer system has changed from the first context (e.g., the context associated with user interface 600k3 shown in FIG. 6K) to a second context (e.g., the context associated with user interface 600k2 shown in FIG. 6K) that does not meet the first set of context criteria (e.g., in response to detecting a change in context of the computer system to a context that is determined to not meet the first set of context criteria and/or in accordance with a determination that the first set of context criteria is no longer met). In some embodiments, the contextual notification is applicable, relevant, and/or pertinent in the first context. In some embodiments, the contextual notification is not (or, in some embodiments, no longer) applicable, relevant, and/or pertinent in the second context. In some embodiments, the contextual notification is less applicable, relevant, and/or pertinent in the second context than in the first context.

In some embodiments, in response to detecting the change in context of the computer system from the first context to the second context, the computer system automatically (e.g., without and/or independently of user input) dismisses (706) the contextual notification (e.g., as shown in user interface 600j in FIG. 6J). In some embodiments, the computer system ceases to display the contextual notification while maintaining display of the first content or forgoing displaying the contextual notification the next time that the first user interface is displayed. In some embodiments, the computer system continues displaying the first content (e.g., the first user interface with the first content remains) after the contextual notification is dismissed. Displaying a contextual notification based on a context of the computer system provides a user with feedback that the context of the computer system is the first context, thereby providing the user with improved visual feedback. Displaying the contextual notification based on the context of the computer system enables the user to view and access the contextual notification when relevant while keeping the user interface less cluttered when the contextual notification is not relevant, thereby providing a more efficient user interface. Automatically dismissing the contextual notification in response to detecting the change in the context of the computer system provides a user with feedback that the context of the computer system changed from the first context to the second context, thereby providing the user with improved visual feedback. Automatically dismissing the contextual notification in response to detecting the change in the context of the computer system reduces the number of inputs required to dismiss the contextual notification, thereby performing an operation when a set of conditions has been met without requiring further user input and reducing the number of inputs needed to perform an operation.

In some embodiments, before displaying the contextual notification, the computer system displays, via the one or more display generation components, the first user interface with the first content. In some embodiments, displaying the contextual notification includes overlaying the contextual notification on the first content that was already being displayed in the first user interface (e.g., background content 610 and weather complication 612 were already being displayed in user interface 600a shown in FIG. 6A and contextual notification 624 is overlaid on the content in user interface 600c shown in FIG. 6C). In some embodiments, the computer system displays the first user interface with the first content before displaying the contextual notification overlaid on the first user interface with the first content (e.g., before the context of the computer system is the first context that meets a first set of context criteria). Displaying a contextual notification overlaid on content that was already being displayed in the first user interface based on a context of the computer system provides a user with feedback regarding the context of the computer system, thereby providing the user with improved visual feedback. Displaying the contextual notification overlaid on content that was already being displayed in the first user interface based on the context of the computer system enables the user to view and access the contextual notification when relevant while keeping the user interface less cluttered when the contextual notification is not relevant, thereby providing a more efficient user interface.

In some embodiments, displaying the contextual notification includes displaying the contextual notification overlaid on the content of the first user interface in response to receiving, via one or more input devices, a first input (e.g., a contact, press of a button, rotation of a rotatable input mechanism, motion of at least a portion of the computer system, an audio input, and/or a gesture) corresponding to a request to display the first user interface (e.g., in response to detecting a wrist raise gesture, the computer system displays user interface 600c including contextual notification 624 overlaid on background content 610 and weather complication 612). In some embodiments, the first input corresponds to a request to transition the computer system from an inactive state (e.g., a low-power state, a reduced-power state, a sleep state, and/or a dimmed state) to a standard state and/or a higher-power state (e.g., a state in which the computer system uses more power, on average, than in the low-power state, reduced-power state, sleep state, and/or dimmed state). In some embodiments, the first user interface with the first content is not being displayed at the time the first input is received. Displaying a contextual notification overlaid on content of the first user interface in response to receiving a first input reduces the number of inputs required to display the contextual notification, thereby performing an operation when a set of conditions has been met without requiring further user input and reducing the number of inputs needed to perform an operation.

In some embodiments, the computer system detects, via one or more input devices, a respective input (e.g., 658, a contact, a button press, a knob rotation, an air gesture, a tap, and/or a swipe) directed to the first user interface. In some embodiments, the respective input directed to the first user interface is directed toward the contextual notification. In some embodiments, in response to detecting the respective input directed to the first user interface and in accordance with a determination that the respective input directed to the first user interface corresponds to a request to select (e.g., activate) the contextual notification, the computer system performs the action corresponding to the contextual notification (e.g., displays a plurality of selectable user interface objects as shown in user interface 600d in FIG. 6D, displays an application user interface as shown in user interface 600e in FIG. 6E, and/or initiates a function, such as the hiking tracking function shown in user interface 600g in FIG. 6G). In some embodiments, in accordance with a determination that the respective input directed to the first user interface does not correspond to a request to select the contextual notification, the computer system forgoes performing the action corresponding to the contextual notification. In some embodiments, the respective input directed to the first user interface is a tap, a selection, and/or an activation input directed to the contextual notification. In some embodiments, the action corresponding to the contextual notification includes displaying information regarding the contextual notification. In some embodiments, the action corresponding to the contextual notification includes displaying an application corresponding to the contextual notification. In some embodiments, the action corresponding to the contextual notification includes initiating a process relating to the contextual notification (e.g., initiating a process for tracking and/or recording information). In some embodiments, the action corresponding to the contextual notification includes activating or deactivating a function, such as turning on a setting or turning off a setting. Performing the action corresponding to the contextual notification in response to detecting the respective input directed to the first user interface and in accordance with a determination that the respective input directed to the first user interface corresponds to a request to select the contextual notification reduces the number of inputs required to perform the action, thereby performing an operation when a set of conditions has been met without requiring further user input and reducing the number of inputs needed to perform an operation. Performing the action corresponding to the contextual notification in response to detecting the respective input directed to the first user interface and in accordance with a determination that the respective input directed to the first user interface corresponds to a request to select the contextual notification enables a user to quickly perform the action corresponding to the contextual notification when the action is relevant while keeping the user interface less cluttered when the contextual notification is not relevant, thereby providing a more efficient user interface.

In some embodiments, in response to detecting the respective input directed to the first user interface and in accordance with the determination that the respective input directed to the first user interface corresponds to the request to select the contextual notification, the computer system displays, via the one or more display generation components, additional information associated with the contextual notification (e.g., top widget 620a and/or additional information that is not included in the first user interface or the contextual notification, such as tracking icon 626 and the text shown in top widget 620a in FIG. 6D). In some embodiments, performing the action corresponding to the contextual notification includes displaying the additional information associated with the contextual notification. Displaying additional information associated with the contextual notification in response to detecting a respective input directed to the first user interface that corresponds to a request to select the contextual notification provides a user with feedback regarding the context of the computer system, thereby providing the user with improved visual feedback. Displaying additional information associated with the contextual notification in response to detecting a respective input directed to the first user interface that corresponds to a request to select the contextual notification reduces the number of inputs required to display additional information associated with the contextual notification, thereby performing an operation when a set of conditions has been met without requiring further user input and reducing the number of inputs needed to perform an operation. Displaying additional information associated with the contextual notification in response to detecting a respective input directed to the first user interface that corresponds to a request to select the contextual notification enables the user to view the additional information associated with the contextual notification when the contextual notification is relevant while keeping the user interface less cluttered when the contextual notification is not relevant, thereby providing a more efficient user interface.

In some embodiments, in response to detecting the respective input directed to the first user interface and in accordance with the determination that the respective input directed to the first user interface corresponds to the request to select the contextual notification, the computer system displays, via the one or more display generation components, a second user interface (e.g., user interface 600d shown in FIG. 6D) that is different from the first user interface. In some embodiments, the second user interface includes a first plurality (e.g., a set, collection, and/or stack) of selectable user interface objects (e.g., widget stack 620, including top widget 620a, middle widget 620b, and bottom widget 620c, and/or user interactive notifications, alerts, and/or status indicators). In some embodiments, the additional information associated with the contextual notification is displayed in a first selectable user interface object (e.g., top widget 620a, the top and/or front selectable user interface object) of the first plurality of the selectable user interface objects. In some embodiments, the selectable user interface object with the additional information associated with the contextual notification is selectable to display, launch, and/or open an application associated with the contextual notification. Displaying the additional information associated with the contextual notification in a first selectable user interface object of a plurality of selectable user interface objects provides a user with feedback regarding the context of the computer system, thereby providing the user with improved visual feedback. Displaying the additional information associated with the contextual notification in a first selectable user interface object in a second user interface in response to detecting a respective input directed to the first user interface that corresponds to a request to select the contextual notification enables the user to view the second user interface and the additional information associated with the contextual notification when the contextual notification is relevant while keeping the user interface less cluttered when the contextual notification is not relevant, thereby providing a more efficient user interface.

In some embodiments, in response to detecting the respective input directed to the first user interface and in accordance with the determination that the respective input directed to the first user interface corresponds to a request to select the contextual notification: in accordance with a determination that a confidence level (e.g., 690) regarding the contextual notification is above (e.g., greater than) a threshold, the computer system performs the action (e.g., initiates a process relating to the contextual notification) corresponding to the contextual notification. In some embodiments, the confidence level represents the likelihood that the contextual notification is relevant to the user. In some embodiments, the computer system determines the confidence level based on the context of the computer system. FIGS. 6K-6N illustrate exemplary actions associated with different confidence levels. For example, in accordance with a determination that the confidence level is above a medium certainty threshold, the computer system displays a contextual notification overlaid on content of a user interface, as shown in user interfaces 600k3, 600l3, 600m3, and 600n3. As another example, in accordance with a determination that the confidence level is above a high certainty threshold, the computer system displays a contextual notification in a widget stack, as shown in user interfaces 600k4, 600l4, 600m4, and 600n4. As another example, in accordance with a determination that the confidence level is above the very high certainty threshold, the computer system initiates recording a hiking route, as shown in user interface 600k5, or the computer system turns on a flashlight, as shown in user interface 600n5. In some embodiments, in response to detecting the respective input directed to the first user interface and in accordance with the determination that the respective input directed to the first user interface corresponds to a request to select the contextual notification: in accordance with a determination that the confidence level regarding the contextual notification is below (e.g., less than) the threshold, the computer system displays additional information associated with the contextual notification (e.g., overlaid on content of a user interface and/or in top widget 620a of widget stack 620) without performing the action corresponding to the contextual notification (e.g., without initiating recording a hiking route). Performing the action in accordance with a determination that the confidence level regarding the contextual notification is above a threshold reduces the number of inputs required to perform the action, thereby performing an operation when a set of conditions has been met without requiring further user input and reducing the number of inputs needed to perform an operation. Performing the action in accordance with a determination that the confidence level regarding the contextual notification is above a threshold provides a user with feedback regarding the confidence level that the context of the computer system is the first context, thereby providing the user with improved visual feedback. Performing the action in accordance with a determination that the confidence level regarding the contextual notification is below the threshold in response to detecting a respective input directed to the first user interface that corresponds to a request to select the contextual notification enables the user to quickly perform the action when the contextual notification is relevant while keeping the user interface less cluttered when the contextual notification is not relevant, thereby providing a more efficient user interface. Displaying additional information associated with the contextual notification in accordance with a determination that the confidence level regarding the contextual notification is below the threshold reduces the number of inputs required to display the additional information, thereby performing an operation when a set of conditions has been met without requiring further user input and reducing the number of inputs needed to perform an operation. Displaying additional information associated with the contextual notification in accordance with a determination that the confidence level regarding the contextual notification is below the threshold provides a user with feedback regarding the confidence level that the context of the computer system is the first context, thereby providing the user with improved visual feedback. Displaying additional information associated with the contextual notification in accordance with a determination that the confidence level regarding the contextual notification is below the threshold in response to detecting a respective input directed to the first user interface that corresponds to a request to select the contextual notification enables the user to view the additional information associated with the contextual notification when the contextual notification is relevant while keeping the user interface less cluttered when the contextual notification is not relevant, thereby providing a more efficient user interface.

In some embodiments, in response to detecting the respective input directed to the first user interface and in accordance with a determination that the respective input directed to the first user interface corresponds to a request to dismiss the contextual notification (e.g., 660), the computer system ceases to display the contextual notification (e.g., as shown in user interface 600j in FIG. 6J). In some embodiments, the respective input directed to the first user interface corresponding to a request to dismiss the contextual notification is a swipe gesture (e.g., a downward swipe) directed toward the contextual notification. Ceasing to display the contextual notification in response to detecting a respective input directed to the first user interface that corresponds to a request to dismiss the contextual notification reduces the number of inputs required to cease displaying the contextual notification, thereby performing an operation when a set of conditions has been met without requiring further user input and reducing the number of inputs needed to perform an operation. Ceasing to display the contextual notification in response to detecting a respective input directed to the first user interface that corresponds to a request to dismiss the contextual notification removes unwanted information from the user interface, thereby providing a more efficient user interface.

In some embodiments, after ceasing to display the contextual notification, in accordance with a determination that the respective input directed to the first user interface corresponds to a request to dismiss the contextual notification (e.g., 660), the computer system suppresses (e.g., forgoes displaying and/or prevents the contextual notification from being redisplayed, even if other notification criteria are met) the contextual notification for a first period of time (e.g., 5 minutes, 30 minutes, 12 hours, or 1 day). In some embodiments, the contextual notification is suppressed, for the first period of time, in response to the request to dismiss the contextual notification, even if the context of the computer system is the first context that meets the first set of context criteria. For example, in some embodiments, the contextual notification is displayed based on an unhealthy air quality index, as shown in FIG. 6M. In some embodiments, the computer system suppresses the contextual notification for the first period of time (e.g., after ceasing to display the contextual notification in accordance with a determination that the respective input directed to the first user interface corresponds to a request to dismiss the contextual notification) even though the air quality index remains at an unhealthy level and/or the air quality index increases to a very unhealthy level during the first period of time. Suppressing the contextual notification for a first period of time in accordance with a determination that the respective input directed to the first user interface corresponds to a request to dismiss the contextual notification reduces the number of inputs required to suppress displaying the contextual notification, thereby performing an operation when a set of conditions has been met without requiring further user input and reducing the number of inputs needed to perform an operation. Suppressing the contextual notification for a first period of time in accordance with a determination that the respective input directed to the first user interface corresponds to a request to dismiss the contextual notification maintains a less cluttered user interface for the first period of time, thereby providing a more efficient user interface.

In some embodiments, after ceasing to display the contextual notification (e.g., in accordance with a determination that the respective input directed to the first user interface corresponds to a request to dismiss the contextual notification) and while the contextual notification is not being displayed (e.g., while the contextual notification is being suppressed), the computer system detects, via the one or more input devices, an input (e.g., 674, a swipe input, and/or rotation of a rotatable input mechanism) corresponding to a request to display a third user interface (e.g., user interface 600d shown in FIG. 6D) that is different from the first user interface (and is optionally different from the second user interface or the same as the second user interface). In some embodiments, in response to detecting the input corresponding to the request to display the third user interface, the computer system displays, via the one or more display generation components, the third user interface. In some embodiments, the third user interface includes a second plurality (e.g., a set, collection, and/or stack) of selectable user interface objects (e.g., widget stack 620, including top widget 620a, middle widget 620b, and bottom widget 620c). In some embodiments, the second plurality of selectable user interface objects is the same as the first plurality of selectable user interface objects. In some embodiments, the second plurality of selectable user interface objects is different from the first plurality of selectable user interface objects (e.g., includes at least one selectable user interface object that is not included in the first plurality of selectable user interface objects, does not include at least one selectable object that was included in the first plurality of selectable user interface objects, and/or does not include any of the selectable user interface objects that were included in the first plurality of selectable user interface objects). In some embodiments, the second plurality of selectable user interface objects include one or more user interactive notifications, alerts, and/or status indicators. In some embodiments, information associated with the contextual notification is displayed in a first selectable user interface object (e.g., the top and/or front selectable user interface object) of the second plurality of selectable use interface objects. In some embodiments, even after the contextual notification is dismissed from the first user interface, the respective information regarding the contextual notification is still available in the third user interface. Displaying a third user interface that includes a second plurality of selectable user interface objects with respective information associated with the contextual notification after ceasing to display the contextual notification enables a user of the computer system to access the respective information associated with the contextual notification even after the contextual notification has been dismissed, thereby providing the user with improved visual feedback. Displaying the third user interface in response to detecting the input corresponding to the request to display the third user interface reduces the number of inputs required to display the respective information associated with the contextual notification, thereby performing an operation when a set of conditions has been met without requiring further user input and reducing the number of inputs needed to perform an operation. Displaying the third user interface that includes a second plurality of selectable user interface objects with respective information associated with the contextual notification after ceasing to display the contextual notification enables the user to access the respective information while reducing clutter in other user interfaces, thereby providing a more efficient user interface.

In some embodiments, in accordance with a determination that the respective input directed to the first user interface corresponds to the first content (e.g., 662), the computer system performs an operation that is not associated with the contextual notification (e.g., performing an operation that is associated with the first content). In some embodiments, the operation that is not associated with the contextual notification includes displaying additional information associated with the first content and/or displaying an application associated with the first content. Performing an operation that is not associated with the contextual notification in accordance with a determination that the respective input directed to the first user interface corresponds to the first content reduces the number of inputs required to perform the operation that is not associated with the contextual notification, thereby performing an operation when a set of conditions has been met without requiring further user input and reducing the number of inputs needed to perform an operation.

In some embodiments, after displaying a first version (e.g., a first instance or first occurrence) of the first user interface (e.g., user interface 600c) that includes the contextual notification, the computer system ceases to display the first version of the first user interface. In some embodiments, the computer system ceases displaying the first version of the first user interface based on passage of time (e.g., a time out) and/or based on a lower gesture (e.g., the user lowering his wrist and/or the computer system). In some embodiments, after ceasing to display the first version of the first user interface (and, in some embodiments, after displaying a different user interface) and in response to receiving a third input (e.g., a contact, a button press, a knob rotation, an air gesture, a tap, a swipe, and/or a raise gesture), the computer system displays, via the one or more display generation components, a second version of the first user interface (in some embodiments, the first version and the second version of the first user interface are the same, other than the presence or absence of the contextual notification). In some embodiments, the third input includes receipt of an incoming message, call, email, notification, and/or alert. In some embodiments, in accordance with a determination that the contextual notification has been displayed (e.g., in the first user interface and/or in other user interfaces) more than a threshold number of times (e.g., 1 time, 3 times, 5 times, 20 times) without an interaction directed toward the contextual notification, the second version of the first user interface does not include the contextual notification (e.g., user interface 600j). In some embodiments, in accordance with a determination that the contextual notification has not been displayed more than a threshold number of times without interaction directed toward the contextual notification, the second version of the first user interface includes the contextual notification (e.g., user interface 600c) (e.g., the first version of the first user interface is the same as the second version of the first user interface). Displaying a second version of the first user interface that does not include the contextual notification in accordance with a determination that the contextual notification has been displayed more than a threshold number of times without an interaction directed toward the contextual notification reduces the number of inputs required to display the second version of the first user interface that does not include the contextual notification, thereby performing an operation when a set of conditions has been met without requiring further user input and reducing the number of inputs needed to perform an operation. Displaying a second version of the first user interface that does not include the contextual notification in accordance with a determination that the contextual notification has been displayed more than a threshold number of times without an interaction directed toward the contextual notification provides a user of the computer system with an indication that the contextual notification was displayed the threshold number of times without an interaction directed toward the contextual notification, thereby providing the user with improved visual feedback. Displaying a second version of the first user interface that does not include the contextual notification in accordance with a determination that the contextual notification has been displayed more than a threshold number of times without an interaction directed toward the contextual notification removes unwanted information from the first user interface, thereby providing a more efficient user interface.

In some embodiments, after displaying the second version of the first user interface that does not include the contextual notification in accordance with the determination that the contextual notification has not been displayed more than the threshold number of times: in accordance with a determination that a second period of time has not passed (e.g., 1 minute, 5 minutes, 30 minutes), the computer system suppresses (e.g., forgoes displaying and/or prevents the contextual notification from being redisplayed, even if the context of the computer system is the first context that meets the first set of context criteria) the contextual notification (e.g., as shown in user interface 600j). In some embodiments, after displaying the second version of the first user interface that does not include the contextual notification in accordance with the determination that the contextual notification has not been displayed more than the threshold number of times: in accordance with a determination that the second period of time has passed, the computer system ceases to suppress the contextual notification (e.g., resumes displaying the contextual notification based on the context of the computer system being the first context that meets the first set of context criteria, as illustrated by user interface 600c in FIG. 6C). In some embodiments, in accordance with a determination that the contextual notification has not been displayed more than the threshold number of times without interaction directed toward the contextual notification, the second version of the first user interface includes the contextual notification (e.g., the first version of the first user interface is the same as the second version of the first user interface) regardless of whether or not the second period of time has passed. Suppressing the contextual notification for a period of time after displaying the second version of the first user interface that does not include the contextual notification reduces the number of inputs required to suppress the contextual notification over the period of time, thereby performing an operation when a set of conditions has been met without requiring further user input and reducing the number of inputs needed to perform an operation. Suppressing the contextual notification for a period of time after displaying the second version of the first user interface that does not include the contextual notification keeps the first user interface less cluttered for the period of time, thereby providing a more efficient user interface.

In some embodiments, the contextual notification is provided without a corresponding non-visual (e.g., audio and/or tactile) output. Providing the contextual notification without a corresponding non-visual output reduces power usage and improves battery life of the computer system. Providing the contextual notification without a corresponding non-visual output enables a user to distinguish the contextual notification from notifications that are provided with a corresponding non-visual output, thereby providing the user with improved visual feedback.

In some embodiments, an alert (e.g., 614, a notification other than a contextual notification, such as a notification regarding a recently received text message, an incoming call, and/or a missed call) is provided (e.g., displayed) along with a corresponding non-visual (e.g. audio and/or tactile) output. Providing an alert with a corresponding non-visual output and the contextual notification without a corresponding non-visual output enables a user to distinguish between the alert and the contextual notification, thereby providing the user with improved visual feedback.

In some embodiments, the contextual notification includes a simulated lighting effect that appears to cast light onto the first content of the first user interface. In some embodiments, the contextual notification appears to emit light (e.g., is a light source that causes a specular lighting effect). In some embodiments, the first content appears to cast simulated shadows as a result of the simulated lighting effect. Displaying the contextual notification including a simulated lighting effect that appears to cast light onto the first content emphasizes the contextual notification and enables the user to distinguish between notifications that do not include a simulated lighting effect, thereby providing the user with improved visual feedback.

In some embodiments, while displaying the contextual notification, the computer system detects a change in context (e.g., a change from the context associated with user interface 600k3 to the context associated with user interface 600k2 shown in FIG. 6K). In some embodiments, in response to detecting the change in context and in accordance with a determination that a relevance of the contextual notification decreased (e.g., below a threshold relevance value), the computer system ceases to display the contextual notification (e.g., as shown in user interface 600j in FIG. 6J). In some embodiments, in accordance with a determination that the relevance of the contextual notification is below a threshold value, the contextual notification is no longer displayed in the first user interface. In some embodiments, the relevance of the contextual notification decreases based on the context of the computer system no longer being the first context that meets the first set of context criteria. Ceasing to display the contextual notification in response to detecting the change in context and in accordance with a determination that the relevance of the contextual notification decreased provides feedback regarding the change in context, thereby providing the user with improved visual feedback. Ceasing to display the contextual notification in response to detecting the change in context and in accordance with a determination that the relevance of the contextual notification decreased reduces the number of inputs required to cease to display the contextual notification, thereby performing an operation when a set of conditions has been met without requiring further user input and reducing the number of inputs needed to perform an operation. Ceasing to display the contextual notification in response to detecting a change in context and in accordance with a determination that the relevance of the contextual notification decreased removes clutter from the user interface when the contextual notification is less relevant, thereby providing a more efficient user interface.

In some embodiments, in response to detecting the change in context and in accordance with a determination that the relevance of the contextual notification remains above a threshold relevance value (e.g., the relevance of the contextual notification decreased but not below the threshold relevance value), the computer system maintains display of the contextual notification (e.g., as shown in user interface 600c in FIG. 6C). In some embodiments, the computer system maintains display of the contextual notification while the relevance of the contextual notification is above the threshold relevance value. Maintaining display of the contextual notification in response to detecting a change in context and in accordance with a determination that the relevance of the contextual notification remains above a threshold relevance value provides feedback regarding the context, thereby providing the user with improved visual feedback. Maintaining display of the contextual notification in response to detecting a change in context and in accordance with a determination that the relevance of the contextual notification remains above a threshold relevance value maintains relevant information in the user interface, thereby providing a more efficient user interface.

In some embodiments, the contextual notification includes a symbolic representation (e.g., an icon and/or an image) of an action corresponding to the contextual notification, wherein the symbolic representation is different for different actions (e.g., the contextual notifications shown in user interface 600k3, user interface 60013, user interface 600m3, and user interface 600n3 include different icons). In some embodiments, the shape and/or design of the contextual notification relates to the corresponding action and/or the contextual notification includes text, a glyph, or a graphical element that indicates the action corresponding to the contextual notification. Displaying the contextual notification with a symbolic representation of an action corresponding to the contextual notification provides feedback regarding the type of action associated with the contextual notification, thereby providing the user with improved visual feedback.

In some embodiments, after (or, in some embodiments, while) displaying the contextual notification, the computer system detects an increase (e.g., above a threshold value) in relevance of the contextual notification (e.g., confidence level 690). In some embodiments, in response to detecting the increase in relevance of the contextual notification, the computer system automatically (e.g., without and/or independently of user input) performs the action associated with the contextual notification (e.g., displays a plurality of selectable user interface objects as shown in user interface 600d in FIG. 6D, displays an application user interface as shown in user interface 600e in FIG. 6E, and/or initiates a function, such as the hiking tracking function shown in user interface 600g in FIG. 6G). In some embodiments, the action associated with the contextual notification includes initiating a process relating to the contextual notification, such as tracking the location and/or movement of the computer system. Performing the action associated with the contextual notification in response to detecting an increase in relevance of the contextual notification provides feedback regarding the change in context, thereby providing the user with improved visual feedback. Automatically performing the action associated with the contextual notification in response to detecting an increase in relevance of the contextual notification reduces the number of inputs required to perform the action associated with the contextual notification, thereby performing an operation when a set of conditions has been met without requiring further user input and reducing the number of inputs needed to perform an operation.

In some embodiments, while displaying the contextual notification in the first user interface, the computer system detects, via the one or more input devices, an input (e.g., 662, a contact, a tap, a swipe, an audio input, and/or a gesture) corresponding to a request to display a fourth user interface (e.g., user interface 600i). In some embodiments, in response to detecting the input corresponding to the request to display the fourth user interface, the computer system ceases to display the first user interface and displays the fourth user interface with the contextual notification, wherein the fourth user interface is different from the first user interface. In some embodiments, the contextual notification is overlaid on first content of the fourth user interface. In some embodiments, the computer system maintains display of the contextual notification when switching between displaying different user interfaces (e.g., when switching from a system user interface to an application user interface, from an application user interface to a system user interface, and/or between application user interfaces). For example, the computer system maintains display of the contextual notification when switching between the home screen and/or watch face (e.g., user interface 600c) shown in FIG. 6C to the weather application interface (e.g., user interface 600i) shown in FIG. 6I. Ceasing to display the first user interface and displaying the fourth user interface with the contextual notification in response to receiving the request to display the fourth user interface reduces the number of inputs required to display the fourth user interface, thereby performing an operation when a set of conditions has been met without requiring further user input and reducing the number of inputs needed to perform an operation. Displaying the fourth user interface with the contextual notification in response to receiving the request to display the fourth user interface maintains relevant information in the fourth user interface and enables the user to view and access information regarding the contextual notification from the fourth user interface, thereby providing a more efficient user interface.

Note that details of the processes described above with respect to method 700 (e.g., FIG. 7) are also applicable in an analogous manner to the methods described below. For example, method 800 optionally includes one or more of the characteristics of the various methods described above with reference to method 700. For brevity, these details are not repeated below.

FIG. 8 is a flow diagram illustrating a method for using a computer system in accordance with some embodiments. Method 800 is performed at a computer system (e.g., 100, 300, 500, and/or 600, a smartwatch, a smartphone, a smartspeaker, a head-mounted device, a tablet computer, a laptop computer, and/or a desktop computer) that is in communication with one or more display generation components (e.g., 602, a display controller, a display, a touch-sensitive display system, a touchscreen, a head-mounted display, and/or a monitor). In some embodiments, the computer system is optionally in communication with one or more input devices (e.g., 602, 604, 606, a touch-sensitive surface, a touchscreen display, a rotatable input mechanism, a button, a keyboard, a mouse, a joystick, a camera sensor, a light sensor, a motion sensor, and/or a microphone). Some operations in method 800 are, optionally, combined, the orders of some operations are, optionally, changed, and some operations are, optionally, omitted.

As described below, method 800 provides an intuitive way for providing variable confidence notifications. The method reduces the cognitive burden on a user for accessing contextual notifications, thereby creating a more efficient human-machine interface. For battery-operated computing devices, enabling a user to access contextual notifications faster and more efficiently conserves power and increases the time between battery charges.

The computer system (e.g., 600) detects (802) a change in context (e.g., a set of one or more circumstances surrounding the condition and/or state) of the computer system (e.g., as illustrated in FIGS. 6K-6N). In some embodiments, the change in context of the computer system includes a change in date, a time, a location, environmental conditions, occurrence of an event, user activity, activity at a companion device, and/or proximity to an external device. In some embodiments, in response to detecting the change in the context (804): in accordance with a determination that a confidence level (e.g., 690, a numerical value representing a likelihood and/or probability) that the computer system is in a respective context is within a first range of confidence values (e.g., a first set of numerical values, such as a first percentage range), the computer system initiates (806) a process for providing information (e.g., displaying a notification and/or an indication, and/or outputting audio information) about a respective action (e.g., an action and/or operation that a user can take at the computer system, such as launching, opening, and/or viewing an application on the computer system) corresponding to the respective context in a first manner (e.g., at a first size, at a first location, and/or with a first characteristic, such as displaying a contextual notification overlaid on content of a user interface, as shown in user interface 600k3, user interface 60013, user interface 600m3, and user interface 600n3). In some embodiments, in response to detecting the change in context, the computer system detects the confidence level that the computer system is in the respective context. In some embodiments, in accordance with a determination that the confidence level is within a first range, the computer system provides an affordance (e.g., a selectable graphical user interface object) for performing an operation and/or control. In some embodiments, the first range represents no confidence, low confidence, medium confidence, and/or high confidence that the context of the computer system is in a respective context.

In some embodiments, in response to detecting the change in the context (804): in accordance with a determination that the confidence level is within a second range of confidence values (e.g., a second set of numerical values) that is different from the first range (in some embodiments, the first range does not overlap the second range. In some embodiments, the first range is a subset of the second range), the computer system initiates (808) a process for providing information about the respective action corresponding to the respective context in a second manner (e.g., at a second size, at a second location, and/or with a second characteristic, such as displaying a contextual notification in a representation of a plurality of selectable user interface objects, as shown in user interface 600k4, user interface 60014, user interface 600m4, and user interface 600n4) that is different from the first manner. In some embodiments, the second range represents no confidence, low confidence, medium confidence, and/or high confidence that the context of the computer system is in a respective context. Initiating a process for providing information about a respective action corresponding to a respective context in a first manner in response to detecting a change in context and in accordance with a determination that the confidence level that the computer system is in the respective context is within a first range and initiating a process for providing information about a respective action corresponding to a respective context in a second manner in response to detecting a change in context and in accordance with a determination that the confidence level that the computer system is in the respective context is within a second range provides a user with feedback regarding the change in context and the confidence level of the context of the computer system, thereby providing the user with improved feedback. Initiating a process for providing information about a respective action corresponding to a respective context in a first manner in response to detecting a change in context and in accordance with a determination that the confidence level that the computer system is in the respective context is within a first range and initiating a process for providing information about a respective action corresponding to a respective context in a second manner in response to detecting a change in context and in accordance with a determination that the confidence level that the computer system is in the respective context is within a second range enables the user to access information regarding the respective action in different manners based on the confidence level, thereby creating a more efficient user interface.

In some embodiments, the process for providing information about the respective action corresponding to the respective context in the first manner includes: receiving, via one or more input devices, a set of one or more inputs (e.g., 650, 658, a contact, press of a button, rotation of a rotatable input mechanism, movement, audio input, gesture, and/or a combination thereof). In some embodiments, the process for providing information about the respective action corresponding to the respective context in the first manner includes: in response to receiving the set of one or more inputs, providing the information (e.g., displaying a notification and/or a graphical user interface object corresponding to the respective action, such as contextual notification 624 or widget stack 620). In some embodiments, the computer system provides the information in response to receiving a swipe input. In some embodiments, the computer system provides the information in response to receiving a rotation of a rotatable input mechanism. In some embodiments, providing the information includes providing a graphical user interface object with one or more controls for the respective action. Providing the information about a respective action corresponding to the respective context in response to receiving a set of one or more inputs reduces the number of inputs required to provide the information, thereby performing an operation when a set of conditions has been met without requiring further user input and reducing the number of inputs needed to perform an operation.

In some embodiments, providing information about the respective action corresponding to the respective context in the first manner includes performing a first action corresponding to the context of the computer system (e.g., displays a plurality of selectable user interface objects as shown in user interface 600d in FIG. 6D, displays an application user interface as shown in user interface 600e in FIG. 6E, and/or initiates a function, such as the hiking tracking function shown in user interface 600g in FIG. 6G). In some embodiments, performing the first action corresponding to the context of the computer system includes initiating a process corresponding to the context of the computer system, such as initiating a process for tracking and/or recording information relating to the context of the computer system. In some embodiments, performing the first action corresponding to the context of the computer system includes activating or deactivating a function, such as turning on a setting or turning off a setting. In some embodiments, the first manner includes displaying a user interface with information regarding the first action corresponding to the context of the device that is being performed. In some embodiments, performing the first action corresponding to the context of the computer system includes displaying a respective user interface that includes information regarding the context of the computer system. In some embodiments, performing the first action corresponding to the context of the computer system includes displaying the respective user interface that includes information regarding the context of the computer system among a collection of other information (e.g., in a stack of information). In some embodiments, providing information about the respective action corresponding to the respective context in the second manner includes displaying, via the one or more display generation components, a respective contextual notification (e.g., a notification regarding an available action corresponding to the context of the computer system and/or a notification with information corresponding to the context of the computer system) (in some embodiments, without performing the first action) in a first user interface (e.g., user interface 600c in FIG. 6C), wherein the respective contextual notification is overlaid on content of the first user interface (e.g., as shown in user interface 600c in FIG. 6C). Performing a first action corresponding to the contextual notification in response to detecting a change in context and in accordance with a determination that the confidence level that the computer system is in the respective context is within a first range and displaying a respective contextual notification overlaid on content of a first user interface in response to detecting the change in context and in accordance with a determination that the confidence level that the computer system is in the respective context is within a second range provides a user with feedback regarding the change in context and the confidence level of the context of the computer system, thereby providing the user with improved feedback. Performing a first action corresponding to the contextual notification in response to detecting a change in context and in accordance with a determination that the confidence level that the computer system is in the respective context is within a first range and displaying a respective contextual notification overlaid on content of a first user interface in response to detecting the change in context and in accordance with a determination that the confidence level that the computer system is in the respective context is within a second range enables the user to access information regarding the respective action in different manners based on the confidence level, thereby creating a more efficient user interface.

In some embodiments, providing information about the respective action corresponding to the respective context in the second manner includes displaying, via the one or more display generation components, a respective contextual notification (e.g., a notification regarding an available action corresponding to the context of the computer system and/or a notification with information corresponding to the context of the computer system) in a second user interface, wherein the respective contextual notification is overlaid on content of the second user interface (e.g., user interface 600c in FIG. 6C). In some embodiments, the second user interface is the same as the first user interface. In some embodiments, the second user interface is different than the first user interface. In some embodiments, providing information about the respective action corresponding to the respective context in the second manner includes displaying, via the one or more display generation components, in a third user interface (e.g., user interface 600d in FIG. 6D) that is different from the second user interface, the respective contextual notification in a representation of a plurality (e.g., a set, collection, and/or stack) of selectable user interface objects (e.g., widget stack 620, including top widget 620a, middle widget 620b, and bottom widget 620c, and/or user interactive notifications, alerts, and/or status indicators), wherein the representation of the plurality of selectable user interface objects is accessible from, but not displayed in, the second user interface (e.g., widget stack 620 and/or user interface 600d is accessible from user interface 600c via an upward swipe input similar to 650 and/or an upward rotation input similar to 652). In some embodiments, while displaying the second user interface, the computer system detects an input and, in response to detecting the input, the computer system displays, in the third user interface, the set of selectable user interface objects. In some embodiments, the respective contextual notification includes more information when displayed in the third user interface in the third plurality of selectable user interface objects than when displayed in the second user interface overlaid on the second content. Displaying a respective contextual notification overlaid on content of a second user interface in response to detecting a change in context and in accordance with a determination that the confidence level that the computer system is in the respective context is within a first range and displaying the respective contextual notification in a representation of a plurality of selectable user interface objects in response to detecting the change in context and in accordance with a determination that the confidence level that the computer system is in the respective context is within a second range provides a user with feedback regarding the change in context and the confidence level of the context of the computer system, thereby providing the user with improved feedback. Displaying a respective contextual notification overlaid on content of a second user interface in response to detecting a change in context and in accordance with a determination that the confidence level that the computer system is in the respective context is within a first range and displaying the respective contextual notification in a representation of a plurality of selectable user interface objects in response to detecting the change in context and in accordance with a determination that the confidence level that the computer system is in the respective context is within a second range enables the user to access information regarding the respective action in different manners based on the confidence level, thereby creating a more efficient user interface.

In some embodiments, the computer system detects, via one or more input sensors, a first input. In some embodiments, in accordance with a determination that the first input is a first type of input (e.g., 658, a press-and-hold input and/or a tap input directed toward the second contextual notification), the computer system performs the action corresponding to the context of the computer system (e.g., initiating a process corresponding to the context of the computer system, such as tracking a hiking route, as shown in FIG. 6K, and/or turning on a flashlight, as shown in FIG. 6N). In some embodiments, in accordance with a determination that the first input is a second type of input (e.g., 650, 652, a tap input directed toward the second contextual notification, a swipe input, and/or rotation of a rotatable input mechanism), the computer system displays, via the one or more display generation components, the third user interface including the representation of the plurality of selectable user interface objects. In some embodiments, the first type of input is a touch input (e.g., a contact, a tap, and/or a press) directed to the respective contextual notification. In some embodiments, the second type of input is a hardware input (e.g., a rotation of a rotatable input mechanism and/or a press of a depressible input mechanism). Performing the action corresponding to the context of the computer system in accordance with a determination that the first input is a first type of input and displaying the third user interface including the representation of the plurality of selectable user interface objects in accordance with a determination that the first input is a second type of input provides the user with feedback regarding the type of input, thereby providing the user with improved visual feedback, Performing the action corresponding to the context of the computer system in accordance with a determination that the first input is a first type of input and displaying the third user interface including the representation of the plurality of selectable user interface objects in accordance with a determination that the first input is a second type of input enables the user to access information regarding the respective action in different manners based on the type of input, thereby creating a more efficient user interface.

In some embodiments, the first type of input is a swipe input in a first direction (e.g., 660) at a first location on one of the one or more display generation components (e.g., in the second user interface and/or the third user interface). In some embodiments, the swipe input in a first direction is a downward swipe and, in some embodiments, the action corresponding to the context of the computer system is dismissing the contextual notification. In some embodiments, the second type of input is a swipe input in a second direction (e.g., 650) that is different (or, in some embodiments, opposite) from the first direction at a second location on one of the one or more display generation components. In some embodiments, the swipe input in the second direction is an upward swipe. In some embodiments, the first location is the same as the second location. In some embodiments, the first location is different than the second location. Performing the action corresponding to the context of the computer system in accordance with a determination that the first input is a swipe input in the first direction reduces the number of inputs required to perform the action, thereby performing an operation when a set of conditions has been met without requiring further user input and reducing the number of inputs needed to perform an operation. Displaying the third user interface including the third plurality of selectable user interface objects in accordance with a determination that the first input is a swipe input in a second direction reduces the number of inputs required to display the third user interface, thereby performing an operation when a set of conditions has been met without requiring further user input and reducing the number of inputs needed to perform an operation.

In some embodiments, before detecting the change in context of the computer system, the computer system displays a respective user interface that includes content (e.g., user interface 600c). In some embodiments, providing information about the respective action corresponding to the respective context in the first manner includes displaying, via the one or more display generation components, a respective contextual notification (e.g., 624, a notification regarding an available action corresponding to the context of the computer system and/or a notification with information corresponding to the context of the computer system), wherein the respective contextual notification is overlaid on the content of the respective user interface (e.g., as shown in user interface 600c in FIG. 6C). In some embodiments, providing information about the respective action corresponding to the respective context in the second manner includes displaying, via the one or more display generation components, the respective contextual notification in a representation of a plurality (e.g., set, collection, and/or stack) of selectable user interface objects (e.g., widget stack 620, including top widget 620a, middle widget 620b, and bottom widget 620c, and/or user interactive notifications, alerts, and/or status indicators), wherein the representation of the plurality of selectable user interface objects is displayed in a location where at least a portion of the content of the respective user interface was previously displayed (e.g., the respective user interface and/or the content of the respective user interface is replaced, at least in part, by the representation of the plurality of selectable user interface objects, as illustrated by the change from user interface 600c to user interface 600d). Displaying a respective contextual notification overlaid on content of a respective user interface in response to detecting a change in context and in accordance with a determination that the confidence level that the computer system is in the respective context is within a first range and displaying the respective contextual notification in a representation of a plurality of selectable user interface objects in response to detecting a change in context and in accordance with a determination that the confidence level that the computer system is in the respective context is within a second range provides a user with feedback regarding the change in context and the confidence level of the context of the computer system, thereby providing the user with improved visual feedback. Displaying a respective contextual notification overlaid on content of a fourth user interface in response to detecting a change in context and in accordance with a determination that the confidence level that the computer system is in the respective context is within a first range and displaying the respective contextual notification in a representation of a plurality of selectable user interface objects in response to detecting a change in context and in accordance with a determination that the confidence level that the computer system is in the respective context is within a second range enables the user to access information regarding the respective action in different manners based on the confidence level, thereby creating a more efficient user interface.

In some embodiments, providing information about the respective action corresponding to the respective context in the first manner includes displaying a respective contextual notification (e.g., a notification regarding an available action corresponding to the context of the computer system and/or a notification with information corresponding to the context of the computer system) in a first location (e.g., position, such as in top widget 620a as shown in FIG. 6D) in a representation of a plurality (e.g., set, collection, and/or stack) of selectable user interface objects (e.g., widget stack 620, including top widget 620a, middle widget 620b, and bottom widget 620c, and/or user interactive notifications, alerts, and/or status indicators). In some embodiments, providing information about the respective action corresponding to the respective context in the second manner includes displaying the respective contextual notification in a second location (e.g., position, such as in middle widget 620b as shown in FIG. 6B) in the representation of the plurality of selectable user interface objects that is different from the first location in the representation of the plurality of selectable user interface objects. Displaying a respective contextual notification in a first location in a representation of a plurality of selectable user interface objects in response to detecting a change in context and in accordance with a determination that the confidence level that the computer system is in the respective context is within a first range and displaying the respective contextual notification in a second location in the representation of the plurality of selectable user interface objects in response to detecting the change in context and in accordance with a determination that the confidence level that the computer system is in the respective context is within a second range provides a user with feedback regarding the change in context and the confidence level of the context of the computer system, thereby providing the user with improved visual feedback. Displaying a respective contextual notification in a first location in a representation of a plurality of selectable user interface objects in response to detecting a change in context and in accordance with a determination that the confidence level that the computer system is in the respective context is within a first range and displaying the respective contextual notification in a second location in the representation of the plurality of selectable user interface objects in response to detecting the change in context and in accordance with a determination that the confidence level that the computer system is in the respective context is within a second range enables the user to access information regarding the respective action in different manners based on the confidence level, thereby creating a more efficient user interface.

In some embodiments, in response to detecting the change in context of the computer system and in accordance with a determination that the confidence level that the computer system is in a respective context is within a third range of confidence values (e.g., a third set of numerical values) that is different than the first range and the second range, the computer system initiates a process for providing information about the respective action corresponding to the respective context in a third manner that is different from the first manner and the second manner. In some embodiments, the third range represents no confidence, low confidence, medium confidence, and/or high confidence that the context of the computer system is in a respective context. In some embodiments, the first manner includes performing an action corresponding to the context of the computer system, the second manner includes displaying a respective contextual notification overlaid on content of a user interface, and the third manner includes displaying the respective contextual notification in a representation of a plurality of selectable user interface objects. Initiating a process for providing information about the respective action corresponding to the respective context in a third manner in response to detecting the change in context of the computer system and in accordance with a determination that the confidence level that the computer system is in a respective context is within a third range provides feedback regarding the change in context and the confidence level of the context of the computer system, thereby providing the user with improved feedback. Initiating a process for providing information about the respective action corresponding to the respective context in a third manner in response to detecting the change in context of the computer system and in accordance with a determination that the confidence level that the computer system is in a respective context is within a third range enables the user to access information regarding the respective action in different manners based on the confidence level, thereby creating a more efficient user interface.

In some embodiments, in response to detecting the change in context of the computer system and in accordance with a determination that the confidence level that the computer system is in the respective context is within a fourth range of confidence values (e.g., a fourth set of numerical values) that is different than the first range, the second range, and the third range, the computer system forgoes displaying information about the respective action corresponding to the respective context (e.g., the computer system does not display a contextual notification regarding the respective context, as illustrated by user interface 600j in FIG. 6J). In some embodiments, forgoing displaying information about the respective action corresponding to the respective context includes forgoing displaying (or, in some embodiments, ceasing to display) a respective contextual notification overlaid on content of a user interface and/or forgoing displaying (or, in some embodiments, ceasing to display) a respective contextual notification in a representation of a plurality of selectable user interface objects. Forgoing displaying information about the respective action corresponding to the respective action in response to detecting a change in context of the computer system and in accordance with a determination that the confidence level that the computer system is in the respective context is within a fourth range provides feedback regarding the change in context and the confidence level of the context of the computer system, thereby providing the user with improved visual feedback. Forgoing displaying information about the respective action corresponding to the respective action in response to detecting a change in context of the computer system and in accordance with a determination that the confidence level that the computer system is in the respective context is within a fourth range keeps the user interface less cluttered when information is not relevant, thereby providing a more efficient user interface.

In some embodiments, the information about the respective action is determined based on a location (e.g., a GPS and/or physical location) of the computer system changing (e.g., increasing or decreasing) a confidence level (e.g., 690) that the respective action is relevant (e.g., as illustrated in FIG. 6K). In some embodiments, the information about the respective action that is determined based on the location of the computer system changing a confidence level that the respective action is relevant includes information regarding turning on/off airplane mode, turning on/off theater mode, displaying a boarding pass, displaying an airport map, displaying local tide information, displaying local weather information, and/or displaying a tip calculator. Initiating a process for providing information based on a location of the computer system changing a confidence level that the respective action is relevant provides feedback regarding the location of the computer system, thereby providing the user with improved visual feedback.

In some embodiments, the information about the respective action is determined based on a time (e.g., a current time, time of day, day, week, and/or month) and/or a routine changing (e.g., increasing or decreasing) a confidence level (e.g., 690) that the respective action is relevant (e.g., pattern of user behavior at the computer system) (e.g., as illustrated by FIG. 6L). In some embodiments, the information about the respective action that is determined based on the time and/or the routine changing a confidence level that the respective action is relevant includes information about displaying reminders regarding an appointment, event, logging medications, performing a workout, and/or completing an activity (e.g., movement goal). Initiating a process for providing information based on a time and/or routine changing a confidence level that the respective action is relevant provides feedback regarding the time and/or routine, thereby providing the user with improved visual feedback.

In some embodiments, the information about the respective action is determined based on one or more environmental conditions changing (e.g., increasing or decreasing) a confidence level (e.g., 690) that the respective action is relevant (e.g., weather conditions, lighting conditions, audio conditions, and/or proximity to utilities) (e.g., as illustrated in FIG. 6M and FIG. 6N). In some embodiments, the information about the respective action that is determined based on one or more environmental conditions changing a confidence level that the respective action is relevant includes information regarding turning a flashlight on/off, performing music recognition, connecting to a satellite, and/or joining wireless internet. Initiating a process for providing information based on one or more environmental conditions changing a confidence level that the respective action is relevant provides feedback regarding the environmental conditions, thereby providing the user with improved visual feedback.

In some embodiments, the information about the respective action is determined based on detected user activity changing (e.g., increasing or decreasing) a confidence level (e.g., 690) that the respective action is relevant (e.g., historical activity and/or a pattern of user activity) (e.g., as illustrated in FIG. 6K). In some embodiments, the information about the respective action that is determined based on user activity changing a confidence level (e.g., 690) that the respective action is relevant includes information about performing a workout, tracking movement (e.g., location) of the user and/or the computer system. Initiating a process for providing information based on user activity changing a confidence level that the respective action is relevant provides feedback regarding the user activity, thereby providing the user with improved visual feedback.

In some embodiments, the information about the respective action is determined based on detected activity at a companion device changing (e.g., increasing or decreasing) a confidence level (e.g., 690) that the respective action is relevant (e.g., an associated and/or linked device, such as a watch, phone, tablet, and/or laptop computer having the same user login and/or account information and that is in communication with the computer system). For example, in some embodiments, the computer system displays a remote control (e.g., remote camera control) based on the user launching, opening, and/or displaying a respective application (e.g., camera application) on the companion device. Initiating a process for providing information based on activity at a companion device changing a confidence level that the respective action is relevant provides feedback regarding the activity at the companion device, thereby providing the user with improved visual feedback.

In some embodiments, the information about the respective action is determined based on detected proximity to an external device changing (e.g., increasing or decreasing) a confidence level (e.g., 690) that the respective action is relevant (e.g., a smart speaker, smart TV, smart home device, and/or home hub). In some embodiments, the information about the respective action that is determined based on proximity to an external device changing a confidence level that the respective action is relevant includes information regarding displaying a status of the external device and/or connecting to the external device. Initiating a process for providing information based on proximity to an external device changing a confidence level that the respective action is relevant provides feedback regarding the proximity of the external device, thereby providing the user with improved visual feedback.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for turning on and/or off an airplane mode (e.g., in accordance with a determination that the computer system is located at an airport and/or on an airplane). In some embodiments, when activated, the airplane mode disconnects the computer system from cellular service and/or WiFi networks.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for turning on and/or off a theater mode (e.g., in accordance with a determination that the computer system is located at a movie theater and/or event venue). In some embodiments, when activated, the theater mode causes the computer system to dim the one or more display generation components and/or suppress (e.g., forgo providing) some or all notifications and/or alerts.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for a ticket and/or boarding pass (e.g., in accordance with a determination that the computer system is at an airport, bus station, train station, and/or event venue).

In some embodiments, the computer system displays a reminder (e.g., in contextual notification 624 as shown in FIG. 6C and/or in top widget 620a as shown in FIG. 6D) (e.g., in accordance with a determination regarding the location of the computer system and/or the current time). For example, in some embodiments, the computer system displays a reminder regarding an upcoming meeting and/or appointment based on the current time. As another example, in some embodiments, the computer system displays a reminder regarding a road closure based on the location of the computer system.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for managing a medication reminder (e.g., in accordance with a determination regarding the current time). In some embodiments, the medication reminder prompts a user of the computer system to take and/or log taking a particular medication.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for managing a severe weather alert (e.g., in accordance with a determination that severe weather is expected at the location of the computer system). In some embodiments, the severe weather alert includes a warning regarding poor air quality, extreme temperatures, high winds, rain, ice, and/or snow accumulation. In some embodiments, a contextual notification indicating a severe weather alert is only shown one time (or, in some embodiments, one set of times) within a predetermined period of time (e.g., a 24-hour period).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for starting to record a workout (e.g., in accordance with a determination that a user of the computer system is currently exercising and/or typically exercises at the current time and/or location of the computer system (such as at a gym)). In some embodiments, in accordance with a determination that the confidence level that the user is currently exercising is a medium confidence level, the computer system prompts the user to start recording the workout (in some embodiments, in accordance with a determination that the confidence level that the user is currently exercising is a high confidence level, the computer system automatically begins recording the workout).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for establishing a satellite connection (e.g., in accordance with a determination that the computer system is not connected to cellular service and/or is located in a remote area for a predetermined period of time). In some embodiments, the computer system displays information regarding the availability of a satellite connection. In some embodiments, the satellite connection is used to send and/or receive voice, text, and/or image messages.

In some embodiments, providing information about the respective action includes initiating a process to record the location of the computer system (e.g., in accordance with a determination that the computer system is moving through a remote area, as shown and described in more detail with respect to FIGS. 6A-6K).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for completing a movement goal (e.g., in accordance with a determination regarding the time of day and/or the current progress toward completing the movement goal). In some embodiments, the computer system displays a suggestion for an activity to perform in furtherance of a movement goal (e.g., in accordance with a determination regarding the current progress toward completing the movement goal). For example, in some embodiments, the computer system suggests that a user of the computer system take a short walk to complete a movement goal based on a determination that the movement goal has not been completed by 4:00 pm. In some embodiments, the suggestion for the activity to perform includes a selectable option to start recording information for a workout (e.g., monitoring activity such as movement and/or biometric signals to determine one or more properties of the activity such as distance, speed, calories burned, or other workout metrics).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for presenting song information (e.g., in accordance with a determination that a song is currently playing). In some embodiments, the computer system displays the indication that song information is available the first time that music is detected by the computer system and not subsequent times that music is detected (e.g., the indication that song information is available is displayed once, even if music is detected more than once). In some embodiments, the computer system displays the indication that song information is available no more than once within a predetermined period (e.g., a 24-hour period).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for launching a remote control for a camera application (e.g., in accordance with a determination that a camera application is open on a companion device). In some embodiments, the remote control for the camera application allows a user of the computer system to take a picture via a camera on the companion device by interacting with the computer system.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for turning on and/or off a flashlight (e.g., in accordance with a determination that the computer system detects, via one or more sensors (e.g., an ambient light sensor), that the lighting in the environment surrounding the computer system is below a threshold). In some embodiments, the computer system displays information regarding turning on and/or off the flashlight in accordance with a determination that the computer system is not in an always-on state and/or lower-power mode (e.g., in accordance with a determination that the computer system is in a standard mode).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for joining a local and/or public WiFi network (e.g., in accordance with a determination that the computer system is not currently connected to a WiFi network and/or that there are available WiFi networks).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for presenting (e.g., displaying) a location-specific map (e.g., in accordance with a determination that the computer system is at a location that has an available location-specific map and/or that the location-specific map has not been displayed on the computer system within a predetermined period (e.g., that day and/or within a 24-hour period)). In some embodiments, the location-specific map includes a map of an airport, an amusement park, a mall, and/or other attraction.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for presenting (e.g., displaying) local tide conditions (e.g., in accordance with a determination that the computer system is located near a coast and/or that the computer system has not previously displayed the tide information and/or an application corresponding to tide information).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for controlling audio input or output for a device (e.g., in accordance with a determination that the device is within a threshold distance of the computer system, that the device is connected to the computer system, and/or that audio is being played at the device).

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for controlling media playback for a media output device (e.g., in accordance with a determination that the media output device is within a threshold distance of the computer system, that the media output device is connected to the computer system, and/or that the media output device is playing media). For example, the controls for controlling media playback include one or more of: a control for adjusting a volume level of media playback, a control for starting media playback, a control for pausing or stopping media playback, a control for advancing forward through a media item, a control for skipping backward through a media item, a control for skipping to a next media item in a sequence of media items, and/or a control for returning to a previous media item in a sequence of media items.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for turning on and/or off a smart device (e.g., in accordance with a determination that the smart device is within a threshold distance of the computer system and/or that the smart device is connected to the computer system). In some embodiments, a smart device is one or more of a smart light, a smart fan, a smart light shade, a home camera, a home speaker, and/or a smart door lock.

In some embodiments, providing information about the respective action includes displaying, via the one or more display generation components, information (e.g., in contextual notification 624 as shown in FIG. 6C and/or in top widget 620a as shown in FIG. 6D) regarding and/or one or more selectable controls for presenting (e.g., displaying) a tip calculator (e.g., in accordance with a determination that the computer system is located at a restaurant and/or has been located at a restaurant for a predetermined amount of time). In some embodiments, a tip calculator includes controls for calculating a tip or splitting a bill based on the total amount of the bill.

Note that details of the processes described above with respect to method 800 (e.g., FIG. 8) are also applicable in an analogous manner to the methods described above. For example, method 700 optionally includes one or more of the characteristics of the various methods described above with reference to method 800. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of contextual notifications. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted notifications that are of greater interest and/or greater relevance to the user. Accordingly, use of such personal information data enables users to receive tailored notifications. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of personalized notifications, the present technology can be configured to allow users to select to “opt in” or “opt out” of participation in the collection of personal information data during registration for services or anytime thereafter. In another example, users can select not to provide health data for targeted health-related notifications. In yet another example, users can select to limit the length of time health data is maintained or entirely prohibit the development of a baseline health profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, notifications can be selected and delivered to users by inferring preferences based on non-personal information data or a bare minimum amount of personal information, such as the content being requested by the device associated with a user, other non-personal information available, or publicly available information.

What is claimed is:

1. A computer system configured to communicate with one or more display generation components, comprising:
one or more processors; and
memory storing one or more programs configured to be executed by the one or more processors, the one or more programs including instructions for:
displaying, via the one or more display generation components, in a first user interface, a contextual notification, wherein:
the contextual notification is displayed based on a context of the computer system being a first context that meets a first set of context criteria;
the contextual notification is associated with an action that is not displayed as being available in the first user interface other than through interaction with the contextual notification; and
the contextual notification is overlaid on first content of the first user interface;
after concurrently displaying the first content and the contextual notification, detecting that the context of the computer system has changed from the first context to a second context that does not meet the first set of context criteria; and
in response to detecting the change in context of the computer system from the first context to the second context, automatically dismissing the contextual notification.

2. The computer system of claim 1, the one or more programs further including instructions for:
before displaying the contextual notification, displaying, via the one or more display generation components, the first user interface with the first content, and
wherein displaying the contextual notification includes overlaying the contextual notification on the first content that was already being displayed in the first user interface.

3. The computer system of claim 1, wherein displaying the contextual notification includes displaying the contextual notification overlaid on the first content of the first user interface in response to receiving, via one or more input devices, a first input corresponding to a request to display the first user interface.

4. The computer system of claim 1, the one or more programs further including instructions for:
detecting, via one or more input devices, a respective input directed to the first user interface; and
in response to detecting the respective input directed to the first user interface and in accordance with a determination that the respective input directed to the first user interface corresponds to a request to select the contextual notification, performing the action corresponding to the contextual notification.

5. The computer system of claim 4, the one or more programs further including instructions for:
in response to detecting the respective input directed to the first user interface and in accordance with the determination that the respective input directed to the first user interface corresponds to the request to select the contextual notification, displaying, via the one or more display generation components, additional information associated with the contextual notification.

6. The computer system of claim 5, the one or more programs further including instructions for:
in response to detecting the respective input directed to the first user interface and in accordance with the determination that the respective input directed to the first user interface corresponds to the request to select the contextual notification, displaying, via the one or more display generation components, a second user interface that is different from the first user interface, wherein:
the second user interface includes a first plurality of selectable user interface objects; and
the additional information associated with the contextual notification is displayed in a first selectable user interface object of the first plurality of the selectable user interface objects.

7. The computer system of claim 4, the one or more programs further including instructions for:
in response to detecting the respective input directed to the first user interface and in accordance with the determination that the respective input directed to the first user interface corresponds to a request to select the contextual notification:
in accordance with a determination that a confidence level regarding the contextual notification is above a threshold, performing the action corresponding to the contextual notification; and
in accordance with a determination that the confidence level regarding the contextual notification is below the threshold, displaying additional information associated with the contextual notification without performing the action corresponding to the contextual notification.

8. The computer system of claim 4, the one or more programs further including instructions for:
in response to detecting the respective input directed to the first user interface and in accordance with a determination that the respective input directed to the first user interface corresponds to a request to dismiss the contextual notification, ceasing to display the contextual notification.

9. The computer system of claim 8, the one or more programs further including instructions for:
after ceasing to display the contextual notification, in accordance with a determination that the respective input directed to the first user interface corresponds to a request to dismiss the contextual notification, suppressing the contextual notification for a first period of time.

10. The computer system of claim 8, the one or more programs further including instructions for:
after ceasing to display the contextual notification and while the contextual notification is not being displayed, detecting, via the one or more input devices, an input corresponding to a request to display a third user interface that is different from the first user interface; and
in response to detecting the input corresponding to the request to display the third user interface, displaying, via the one or more display generation components, the third user interface, wherein:
the third user interface includes a second plurality of selectable user interface objects; and
information associated with the contextual notification is displayed in a first selectable user interface object of the second plurality of selectable use interface objects.

11. The computer system of claim 4, the one or more programs further including instructions for:
in accordance with a determination that the respective input directed to the first user interface corresponds to the first content, performing an operation that is not associated with the contextual notification.

12. The computer system of claim 1, the one or more programs further including instructions for:
after displaying a first version of the first user interface that includes the contextual notification, ceasing to display the first version of the first user interface;
after ceasing to display the first version of the first user interface and in response to receiving a third input, displaying, via the one or more display generation components, a second version of the first user interface, wherein:
in accordance with a determination that the contextual notification has been displayed more than a threshold number of times without an interaction directed toward the contextual notification, the second version of the first user interface does not include the contextual notification.

13. The computer system of claim 12, the one or more programs further including instructions for:
after displaying the second version of the first user interface that does not include the contextual notification in accordance with the determination that the contextual notification has not been displayed more than the threshold number of times:
in accordance with a determination that a second period of time has not passed, suppressing the contextual notification; and
in accordance with a determination that the second period of time has passed, ceasing to suppress the contextual notification.

14. The computer system of claim 1, wherein the contextual notification is provided without a corresponding non-visual output.

15. The computer system of claim 14, wherein an alert is provided along with a corresponding non-visual output.

16. The computer system of claim 1, wherein the contextual notification includes a simulated lighting effect that appears to cast light onto the first content of the first user interface.

17. The computer system of claim 1, the one or more programs further including instructions for:
while displaying the contextual notification, detecting a change in context; and
in response to detecting the change in context and in accordance with a determination that a relevance of the contextual notification decreased, ceasing to display the contextual notification.

18. The computer system of claim 17, the one or more programs further including instructions for:
in response to detecting the change in context and in accordance with a determination that the relevance of the contextual notification remains above a threshold relevance value, maintaining display of the contextual notification.

19. The computer system of claim 1, wherein the contextual notification includes a symbolic representation of an action corresponding to the contextual notification, wherein the symbolic representation is different for different actions.

20. The computer system of claim 1, the one or more programs further including instructions for:
after displaying the contextual notification, detecting an increase in relevance of the contextual notification; and
in response to detecting the increase in relevance of the contextual notification, automatically performing the action associated with the contextual notification.

21. The computer system of claim 1, the one or more programs further including instructions for:
while displaying the contextual notification in the first user interface, detecting, via the one or more input devices, an input corresponding to a request to display a fourth user interface; and
in response to detecting the input corresponding to the request to display the fourth user interface, ceasing to display the first user interface and displaying the fourth user interface with the contextual notification, wherein the fourth user interface is different from the first user interface.

22. A non-transitory computer-readable storage medium storing one or more programs configured to be executed by one or more processors of a computer system that is in communication with one or more display generation components, the one or more programs including instructions for:
displaying, via the one or more display generation components, in a first user interface, a contextual notification, wherein:
the contextual notification is displayed based on a context of the computer system being a first context that meets a first set of context criteria;
the contextual notification is associated with an action that is not displayed as being available in the first user interface other than through interaction with the contextual notification; and
the contextual notification is overlaid on first content of the first user interface;
after concurrently displaying the first content and the contextual notification, detecting that the context of the computer system has changed from the first context to a second context that does not meet the first set of context criteria; and
in response to detecting the change in context of the computer system from the first context to the second context, automatically dismissing the contextual notification.

23. A method, comprising:
at a computer system that is in communication with one or more display generation components:
displaying, via the one or more display generation components, in a first user interface, a contextual notification, wherein:
the contextual notification is displayed based on a context of the computer system being a first context that meets a first set of context criteria;
the contextual notification is associated with an action that is not displayed as being available in the first user interface other than through interaction with the contextual notification; and
the contextual notification is overlaid on first content of the first user interface;
after concurrently displaying the first content and the contextual notification, detecting that the context of the computer system has changed from the first context to a second context that does not meet the first set of context criteria; and
in response to detecting the change in context of the computer system from the first context to the second context, automatically dismissing the contextual notification.
